(19) United States
(12) Patent Application Publication
(10) Pub. No.: US 2026/0017488 A1
(43) Pub. Date: Jan. 15, 2026

(54) Neural Network Models for Adversarial Robustness using Variational Randomized Smoothing

(71) Applicant: Mitsubishi Electric Research Laboratories, Inc., Cambridge, MA (US)

(72) Inventors: Ryo Hase, Brookline, MA (US); Ye Wang, Andover, MA (US); Toshiaki Koike-Akino, Framingham, MA (US); Jing Liu, Santa Clara, CA (US); Kieran Parsons, Gloucester, MA (US)

(73) Assignee: Mitsubishi Electric Research Laboratories, Inc., Cambridge, MA (US)

(21) Appl. No.: 18/766,876

(22) Filed: Jul. 9, 2024

(51) Int. Cl. G06N 3/0455; G06N 3/094

(52) U.S. Cl. CPC G06N 3/0455; G06N 3/094

(57) ABSTRACT

Embodiments disclose a method and a system for robust transformation of input with a neural network. The method comprises processing the input data with a variational neural network (VNN) trained with ML to produce static parameters including noise level for the input data, injecting a set of random noises sampled on a probabilistic distribution according to the statistic parameters defined by the VNN to produce a set of perturbed input samples. The method comprises processing each of the set of perturbed input samples with a transformation neural network to produce a set of transformations and outputting a combination of the set of transformations as the robust transformation of the input data. Some embodiments consider training the variational neural network and transformation neural network by using adversarial examples from an attack model via alternating, explicit, and implicit gradient frameworks.

### TECHNOLOGICAL FIELD

The present disclosure relates generally to training and use of neural network models, and more particularly to systems and methods for training of neural network models for adversarial robustness.

### BACKGROUND

Neural networks are powerful tools for solving complex tasks across various domains, including image recognition, natural language processing, and autonomous systems. However, the neural networks are susceptible to adversarial examples, where imperceptible perturbations to input data can lead to incorrect outputs, thereby degrading performance of these neural networks. Adversarial attacks crafting adversarial examples may deteriorate prediction results of a neural network by adding small perturbations. Adversarial attacks may potentially compromise the reliability and the security of neural network-based systems.

Adversarial attacks pose significant challenges to the widespread adoption of neural networks in safety-critical applications such as autonomous vehicles, medical diagnosis, and cybersecurity. Traditional defense mechanisms, such as input sanitization and robust optimization, often fall short in providing robust protection against sophisticated adversaries.

In recent years, adversarial training is increasingly used to enhance the robustness of the neural networks against adversarial attacks. Adversarial training involves augmenting the training data with adversarial examples, forcing the neural networks to learn robust features that are resilient to such perturbations. By exposing the neural networks to adversarial examples during training, adversarial training may improve generalization ability and reduce its vulnerability to adversarial manipulation. In certain cases, adversarial purification techniques may be used to reduce the effects of adversarial examples by removing perturbations before they are input to the neural network. Certain defense mechanisms may also focus on techniques to detect adversarial examples before they are input to the neural network or while processing thereof.

Existing adversarial training techniques vary in their formulation, optimization strategies, and computational efficiency. Some methods focus on generating adversarial examples using gradient-based optimization algorithms, while others leverage generative models or evolutionary algorithms to craft adversarial perturbations. Despite the progress in adversarial training, there remains a need for more efficient and effective techniques to provide strong defense against adversarial attacks without sacrificing performance of neural networks.

Accordingly, there is a need for a generalized and robust adversarial defense to overcome the above-mentioned challenges for detecting and avoiding an adversarial attack.

### SUMMARY

Adversarial training is used in the neural networks to enhance the robustness of the neural networks against adversarial attacks. Adversarial attacks involve intentionally perturbing input data in such a way that it leads to incorrect outputs from the neural networks. In the adversarial training, a training process is augmented by injecting adversarial examples into a training dataset. These adversarial examples are small input perturbations that degrade the performance of the neural networks. By exposing the neural networks to these adversarial examples during training, the neural networks learn to better recognize and adapt to adversarial perturbations, thereby improving robustness of the neural networks.

However, effectiveness of adversarial training heavily depends on quality and diversity of the adversarial examples in the training dataset used during the training process. Generating high-quality adversarial examples requires careful consideration of various factors, including various attack strategies, model architecture, and training objectives. Therefore, if adversarial examples in the training dataset do not satisfy these various factors, the adversarial training of a neural network may remain ineffective against several adversarial attacks and may result in suboptimal performance of the neural network owing to the training on perturbed samples/data.

In certain cases, randomized smoothing may be used alternate to or in addition to the adversarial training to provide enhanced layers of defense against adversarial attacks. Randomized smoothing is a defensive technique to achieve enhanced robustness against adversarial examples. Randomized smoothing improves the robustness of the neural networks against adversarial attacks. Randomized smoothing may utilize principles of statistical smoothing to enhance a neural network's resilience to perturbations in an input space.

Conventional randomized smoothing adds random noise with a fixed noise level for every input sample to smooth out adversarial perturbations. For example, an output of a neural network is perturbed by adding random noise to logits of the neural network. The random noise may be drawn from a distribution with known properties, such as Gaussian or Laplacian distributions. By adding the random noise to the inputs, decision boundaries of the neural network become more uncertain, making it more difficult for adversaries to craft effective adversarial examples.

Randomized smoothing is used as a defense mechanism against adversarial attacks as it introduces a level of uncertainty in predictions of neural networks, which helps in mitigating any impact of adversarial perturbations. A key idea behind randomized smoothing is to trade off some accuracy on clean data for improved robustness against adversarial attacks. In an example, classification performance of a neural network may drop because adding random noise may make classification difficult.

In certain cases, randomized smoothing is used for noised labels, such as under label-flipping attacks. In certain other cases, a denoiser may be incorporated into randomized smoothing to improve classification accuracy. However, the conventional randomized smoothing fails to provide a scheme to select desired or better noise levels as per input.

Some embodiments are based on a realization that instead of using a fixed noise level for all inputs as in conventional randomized smoothing, noise levels suitable for every input might be selected to improve the performance. Some embodiments consider other statistic parameters to be specified, such as the kurtosis besides the noise level or variance.

Some embodiments are based on a realization that it is beneficial to discover a noise level suitable for each input of a smoothed classifier used for randomized smoothing.

Accordingly, an objective of the present disclosure is to address a problem associated with how to discover a noise level suitable for each input of a smoothed classifier used for randomized smoothing.

Some embodiments of the present disclosure introduce a variational framework to build a noise level selector composed of a neural network to determine input sample-wise noise levels for randomized smoothing.

According to embodiments of the present disclosure, the noise level selector is added to a neural network architecture to improve the randomized smoothing. The noise level selector enables a smoothed classifier to use noise level a suitably selected for each input x to improve prediction results.

Some embodiments of the present disclosure disclose adding a noise level selector to an architecture of a neural network for performing randomized smoothing. The noise level selector enables a smoothed classifier to use a noise level, a, suitably selected for each input sample, x, to improve prediction results.

Another objective of the present disclosure is to provide a generalized training scheme for the noise level selector using stochastic regularization. The stochastic regularization enables the noise level selector to learn various conditions to produce different noise strength at once by randomly sampling a regularization parameter, λ. Further, controllability in the generalized training is improved by using conditional meta learning, which enables to freely adjust a noise strength for different input samples by specifying λ at test time without re-training.

Furthermore, in order to protect a neural network of the noise level selector from adversarial attacks, a defensive method is disclosed. The defense method is implemented as a dual smoothing technique that protects the noise level selector as well as a base classifier neural network. Accordingly, the dual smoothing-based defense technique provides enhanced robustness for sample-wise smoothing, based on a bound of median smoothing.

Accordingly, an embodiment of the present disclosure provides a computer-implemented artificial intelligence (AI) method for robust transformation of input data with a neural network. The AI method comprises processing the input data with a variational neural network (VNN) trained with machine learning to produce statistic parameters including noise level for the input data. The AI method comprises injecting a set of random noises sampled on a probabilistic distribution according to the statistic parameters defined by the variational neural network to produce a set of perturbed input samples. The AI method comprises processing each of the set of perturbed input samples with a transformation neural network to produce a set of transformations. Further, the AI method comprises outputting a combination of the set of transformations as the robust transformation of the input data.

According to some embodiments, the transformation neural network is a classifier such that the robust transformation of the input data includes a classification of the input data.

According to some embodiments, the variational neural network accepts a noise strength scaler as a parameter to adjust a strength of the noise level based on the noise strength scaler.

According to some embodiments, the variational neural network is a single model trained for different values of the noise strength scaler used as a regularization parameter.

According to some embodiments, the variational neural network is trained with a stochastic regularization to produce the noise level of different strengths by randomly sampling the regularization parameter according to a random distribution.

According to some embodiments, the variational neural network is trained with a weighted, scaled, and biased loss function according to the value of the randomly sampled regularization parameter.

According to some embodiments, the AI method further comprises accepting a value of the noise strength scaler from a user interface.

According to some embodiments, the AI method further comprises processing the robust transformation of the input data by a downstream application to perform a task. The AI method further comprises receiving a state of the task as a feedback signal from the downstream application and adjusting a value of the noise strength scaler based on the state of the task.

According to some embodiments, the robust transformation of the input data is performed with multi-stage smoothing including a first smoothing to determine the noise level from random perturbation of the input data on a probabilistic distribution with a fixed variance, and a second smoothing to determine the robust transformation of the input data from random perturbation of the input data on a probabilistic distribution having a varying variance defined by the noise level.

According to some embodiments, the AI method further comprises embedding the input data into a continuous space using an encoder, such that one or a combination of the variational neural network and the transformation neural network are applied to the encoding of the input data.

According to some embodiments, the set of random noises includes a set of Gaussian noise tensors, wherein each of the set of Gaussian noise tensors has a shape of a tensor of floating-point values and includes independent Gaussian samples having a mean of zero and a standard deviation defined by the noise level.

According to some embodiments, each of the perturbed input samples is formed by adding the tensor of floating-point values to features of the input data.

According to some embodiments, the transformation neural network is a deep neural network trained with an augmented data with a set of augmentation parameters for one or a combination of automatic image classification, speech recognition, language modeling, log data modeling, and variants thereof.

According to some embodiments, the variational neural network and the transformation neural network accepts the set of augmentation parameters as a conditional information.

According to some embodiments, each of the set of transformations is a tensor of one or more vectors of logits. Moreover, the AI method further comprises converting each of the one or more vectors of logits into a probability vector using a tempered softmax operation with a tempering factor to produce a set of probability vectors. The AI method further comprises averaging the set of probability vectors in a probability space to produce an average probability vector and determining the robust transformation of the input data using the average probability vector.

According to some embodiments, the AI method further comprises converting the average probability vector with log-likelihoods to produce the robust transformation of the input data.

According to some embodiments, each of the set of transformations is a tensor of one or more vectors of logits. Moreover, the AI method further comprises converting each of the one or more vectors of logits into a hard decision by selecting an index of a largest logit value to produce a set of hard decisions and aggregating the set of hard decisions to produce the robust transformation of the input data.

According to some embodiments, the variational neural network is trained to minimize cross entropy (CE) loss and a Kullback-Leibler (KL) divergence by using a regularized loss function combining the CE loss and the KL divergence.

According to some embodiments, the variational neural network and the transformation neural network are fine-tuned at a target condition.

According to some embodiments, the variational neural network and the transformation neural network are trained with adversarial training using adversarially perturbed data according to an adversarial model.

According to some embodiments, the adversarial training uses at least one of: alternating gradient calculation, explicit gradient calculation, or implicit gradient calculation.

In another embodiment, the present disclosure provides a system for robust transformation of input data with a neural network. The system comprises at least one processor and at least one non-transitory memory having computer program code instructions stored thereon that cause the processor to process the input data with a variational neural network trained with machine learning to produce statistic parameters including noise level for the input data. The computer program code instructions cause the processor to inject a set of random noises sampled on a probabilistic distribution according to the statistic parameters defined by the variational neural network to produce a set of perturbed input samples. The computer program code instructions cause the processor to process each of the set of perturbed input samples with a transformation neural network to produce a set of transformations. Further, the computer program code instructions cause the processor to output a combination of the set of transformations as the robust transformation of the input data.

Further features and advantages will become more readily apparent from the following detailed description when taken in conjunction with the accompanying drawings.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a block diagram of a network environment in which a neural network for outputting a robust transformation of input data is implemented, in accordance with some example embodiments of the present disclosure.

FIG. 2A and FIG. 2B illustrate a block diagram of a system for performing randomized smoothing, in accordance with some example embodiments of the present disclosure.

FIG. 3 illustrates a block diagram of a system for performing variational randomized smoothing using the neural network, in accordance with some example embodiments of the present disclosure.

FIG. 4A, FIG. 4B and FIG. 4C are schematic diagrams of aggregation of a set of transformations, according to different example embodiments.

FIG. 5A, FIG. 5B and FIG. 5C depict schematic diagrams of training of a variational neural network to produce a noise level for the input data, in accordance with various example embodiments of the present disclosure.

FIG. 6A illustrates a schematic diagram of training of the variational neural network for variational randomized smoothing, in accordance with some example embodiments of the present disclosure.

FIG. 6B illustrates a schematic diagram of generalized training of the variational neural network for multi-stage variational randomized smoothing, in accordance with some example embodiments of the present disclosure.

FIG. 7A depicts a high-level schematic diagram of the variational neural network to produce a noise level for an input sample, in accordance with some example embodiments of the present disclosure.

FIG. 7B illustrates a schematic illustration of an inner training loop for performing an adversarial training, in accordance with some example embodiments.

FIG. 7C illustrates a schematic illustration of an outer training loop for performing the adversarial training, in accordance with some example embodiments.

FIG. 7D illustrates a high-level schematic illustration of an inner updater for the adversarial training of a neural network, in accordance with some example embodiments.

FIG. 7E illustrates a high-level schematic illustration of an implicit differentiation module for performing the adversarial training of the neural network using implicit differentiation, in accordance with some example embodiments.

FIG. 8 illustrates a block diagram of implementation of the neural network for a downstream task, in accordance with some example embodiments of the present disclosure.

FIG. 9 illustrates a block diagram of implementation of the neural network for outputting a robust transformation of discreet input data, in accordance with some example embodiments of the present disclosure.

FIG. 10A, FIG. 10B and FIG. 10C illustrate exemplary input data, in accordance with some example embodiments of the present disclosure.

FIG. 11 illustrates a flowchart of a computer-implemented AI method for generating robust transformation of the input data, in accordance with some example embodiments of the present disclosure.

FIG. 12 illustrates a block diagram of a computer-based AI system for generating the robust transformation of the input data, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without specific details. In other instances, systems and methods are shown in block diagram form only in order to avoid obscuring the present disclosure.

Throughout the present disclosure, the term “AI system” refers to a computer-based system or software that exhibits characteristics commonly associated with human intelligence. The AI system is designed to perform tasks that typically require human intelligence, such as problem-solving, learning, reasoning, perception, understanding natural language, and decision-making. AI systems can range from simple rule-based programs to sophisticated, self-learning systems.

Pursuant to present disclosure, the AI system may be a sophisticated piece of software that leverages a neural network for generating robust transformations of input data. Such transformations are used to create defense against adversarial attacks.

Some embodiments are based on a recognition that neural networks are susceptible to adversarial input perturbations, which are a family of attacks that produce carefully crafted perturbations to inputs of a neural network that can be both imperceptibly small and arbitrarily modify the output behavior of the neural network towards arbitrary nefarious aims.

Adversarial attacks can be seen across various domains where machine learning models or neural networks are deployed, particularly in safety-critical and security-sensitive applications. For example, adversarial attacks may be seen in neural networks deployed for a number of tasks, such as image classification, natural language processing (NLP), autonomous systems, healthcare, and cybersecurity. For example, adversarial attacks on image classification models may manipulate images in imperceptible ways to cause misclassification. Moreover, adversarial attacks in NLP may manipulate text inputs to cause misinterpretation or incorrect predictions by language models. Further, adversarial attacks on autonomous systems, such as self-driving cars or drones, can have serious safety implications. For example, adversaries could potentially cause autonomous vehicles to make dangerous decisions or navigate incorrectly. Further, in healthcare applications, adversarial attacks could be used to manipulate medical images or patient records, leading to incorrect diagnoses or treatment recommendations. Adversarial attacks in cybersecurity involve exploiting vulnerabilities in machine learning models to evade detection or gain unauthorized access to systems. For instance, generating adversarial examples that bypass malware detection systems or spam filters could pose significant security risks.

Some embodiments are based on a recognition that adversarial training may be performed to improve robustness of a neural network against adversarial attacks. Adversarial training involves using adversarial examples within training datasets to train the neural network. The adversarial examples are slightly, but intentionally, perturbed to create a new example that can be misclassified by the neural network thereby making it robust to such perturbation. To this end, adversarial training is important for mitigating the risks posed by adversarial attacks.

However, the generation of high-quality adversarial examples is challenging. Further, failure in generating high-quality adversarial examples may affect performance of the neural network that is trained on them in detecting an adversarial attack as well as hamper its ability to generate reliable output.

It is an object of some embodiments of the present disclosure to provide an AI method and an AI system for defending against adversarial attacks using variational randomized smoothing. Additionally, or alternatively, it is an object of some embodiments to provide an AI system and an AI method for defending a variational neural network that produces varying noise levels against adversarial attacks using multi-stage randomized smoothing. Some embodiments adjust other statistical parameters, including not only variance but also mean, kurtosis, and other higher moments.

To that end, it is an object of some embodiments to replace or at least complement adversarial training with robust transformations generated using randomized smoothing. Randomized smoothing involves adding random noise to input data of a neural network to drown out the small perturbation of an adversarial input attack. The input data is perturbed multiple times with independent noise samples, then the model is evaluated on each of these noised inputs, and the corresponding outputs are aggregated to produce a final model output. This aggregation of outputs across multiple samples of noise yields a result that represents an average model output over a local region of the original input data (such as an unperturbed image) that suppresses the effect of small adversarial perturbations, which is effective only due to the specific direction of the perturbation. Further, the statistics of the multiple outputs may be analyzed to generate a certified robustness guarantee.

However, injecting a random noise into the input data may damage a quality of data transformation of the input data. To that end, some embodiments are based on recognizing that a level of the noise injected in the input data balances a robustness of the data transformation with its accuracy. In general, it may be possible to estimate a noise level for a specific input of a specific application using a deterministic approach.

However, some embodiments are based on recognizing that there is a statistical dependency between the noise level and content of the input data, and therefore, there is a need to learn this dependency and to adjust the noise level for each or at least some values of the input data to be transformed.

Some embodiments are based on the realization that while it is possible to learn the dependency using various machine-learning techniques, it is advantageous to capture the dependency with a variational framework to build a noise level selector composed of a neural network to determine sample-wise noise levels for randomized smoothing. Doing this in such a manner allows learning the dependency that balances accuracy vs robustness as a function of the input data to be transformed, which in turn allows maintaining this balance automatically for different values of the input data.

Variational Neural Networks (VNNs) are a type of neural network architecture that incorporates ideas from variational inference, a method used in probabilistic modeling. This is done by introducing a variational distribution that approximates a true posterior distribution over parameters given the input data. The parameters of this variational distribution are learned alongside the parameters of the neural network itself.

During training, VNNs seek to minimize a loss function that includes both a term related to the fit of the model to the data (e.g., the negative log-likelihood) and a term that measures the divergence between the variational distribution and the prior distribution over the parameters. This divergence term encourages the variational distribution to stay close to the prior, acting as a regularization term that helps prevent overfitting and encourages the model to capture the inherent uncertainty in the data. For example, in some embodiments, the VNN is trained to minimize cross entropy (CE) loss as well as Kullback-Leibler (KL) divergence by using a regularized loss function combining the CE loss and KL divergence.

Some embodiments are based on the realization that introduction of additional hyperparameters such as a regularization parameter provides a capability to adjust a behavior of the VNNs. However, hyperparameter optimization is challenging as there is no unique optimal solution to realize a best tradeoff between robustness and accuracy over unknown methods and strengths of adversarial attacks. To address this challenge, the present disclosure provides a way to learn a meta VNN model without specifying regularization parameters in a generalized manner. The generalized meta learning is realized by stochastically drawing different regularization parameters. This stochastic regularization technique enables the meta VNN model to perform universally across a wide range of different settings of regularization parameters.

Accordingly, an objective of the present disclosure is to improve training efficiency by avoiding a necessity to learn multiple VNN models at different conditions. According to some embodiments, random samplings of the regularization parameters are based on uniform distribution or non-uniform distribution according to an assumption of an importance range of regularization values. In some embodiments, the randomly sampled regularization parameters are weighted or biased to further encourage the importance range of regularization values.

Some embodiments are further based on a realization that the generalized meta learning through the use of stochastic regularization is enhanced by model agnostic training which assumes additional fine-tuning steps at a specific regularization parameter and another condition such as augmentation noise level are carried out. Using the gradient information through few-shot fine-tuning steps, the generalized meta model may accelerate the fine-tuning steps.

According to some embodiments, conditional meta learning approach is used to further improve the performance and convergence speed. Specifically, the VNNs and classifiers are trained with additional information including sampled regularization values and data augmentation parameters. The conditional VNNs and classifiers enable a capability to adjust the hyperparameter at a downstream test time without the need of re-training at different hyperparameters.

Other embodiments are based on a realization that few-shot model agnostic meta learning can be realized with a computationally efficient implicit gradient calculation. Using an implicit theorem, a gradient calculation of few-shot adaptation can be used to generate a gradient calculation of the meta model. In addition, the implicit gradient can be further applied to imitate adversarial attacks for assisting a defense strength through adversarial training of VNNs and classifiers. In another embodiment, alternating methods are used for adversarial training. In this regard, stochastic descent for VNNs and classifier may take place alternatingly after the stochastic ascent for an adversarial model is conducted. In yet another embodiment, the gradient calculation is explicitly tracked through a few iterations of stochastic ascents to pass back to the stochastic descent process.

Yet another embodiment is based on the realization that because the VNNs for sample-wise randomized smoothing framework can be a target of adversarial attacks, it is advantageous to protect multiple parts of VNNs and classifiers separately. The present disclosure provides a way to defend against strong attacks, by employing multi-stage smoothing. For example, two-stage smoothing or dual smoothing uses two randomized smoothing techniques to individually protect a noise level selection network (referred to as a variational neural network) and a classifier network (referred to as a transformation neural network). For regression problems, such as noise level selection, a median smoothing or mean smoothing may be applied to provide a certified robustness.

According to some embodiments, the dual smoothing may be readily extended to 3-stage, 4-stage, or more-stage smoothing when the VNNs and classifiers are partitioned into multiple components to defend intermediate nodes. For example, the transformation neural network is partitioned into two parts for feature extraction layers and logit generation layers, respectively. The first smoothing is applied to the variational neural network, the second smoothing is applied to the feature extraction layers and the third smoothing is applied to the logit generation layers.

Overview of AI system

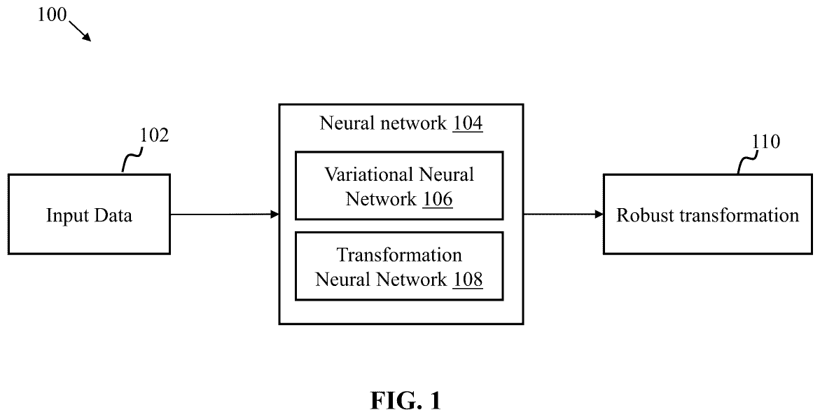

FIG. 1 illustrates a block diagram 100 of a neural network 104 configured to output or generate robust transformation 110, according to some example embodiments of the present disclosure. The neural network 104 is deployed at or used in association with an AI system. The AI system may be a machine or a computation system that is configured to simulate human intelligence processes to perform tasks, such as natural language processing, speech recognition, process automation, robotics, machine vision, etc. In an example, the neural network 104 is configured to generate or output the robust transformation 110 for a ML model, for example, by using input data 102. In particular, the neural network 104 is configured to develop improved defense against adversarial input attacks by using the robust transformations for the input data 102.

The neural network 104 may be a class of machine learning models. For example, the neural network 104 may include interconnected layers of artificial neurons, also known as nodes or units, organized in a hierarchical fashion. Each node may be configured to receive input signals, process them through an activation function, and produce an output signal that is transmitted to another node in a next layer. Further, the different layers of the neural network 104 may include an input layer, hidden layers, and an output layer. In particular, the input layer receives raw input data, such as the input data 102. Examples of the input data may include, but are not limited to, images, text, speech, numerical values, etc. Further, each node of the input layer represents a feature or a dimension of the input data 102. Thereafter, the features of the input data 102 are passed from nodes of the input layer to nodes of the hidden layers. The hidden layers may be intermediate layers between the input layer and the output layer. The hidden layers may perform computations on the input data 102 through weighted connections between the nodes of the hidden layers. Further, after processing through the hidden layers, the nodes of the hidden layers may pass the processed output to nodes of the output layer. The output layer produces final predictions or outputs of the neural network 104.

It may be noted that each connection between the nodes of the layers is associated with a weight, which determines a strength of the connection. Additionally, each node may also have an associated bias term that is added to a weighted sum of inputs before applying an activation function. The activation functions introduce non-linearity into the neural network, enabling it to learn complex relationships in the data. Common activation functions include sigmoid, tanh (hyperbolic tangent), ReLU (Rectified Linear Unit), and softmax.

Pursuant to present disclosure, the input data 102 refers to raw information or observations provided to a model for processing, analysis, and learning. Input data 102 may take various forms depending on a nature of a problem and a type of model being used. Examples of types of input data may include, but are not limited to, structured data (such as, spreadsheets, databases, and CSV files), unstructured data (such as, text documents, images, audio recordings, videos, and categorical variables), time-series data (such as, trends, patterns, and temporal relationships), spatial data, and sensor data.

Typically, adversarial attacks on input data involve modifying values of input data features or changing a structure of the input data to induce misclassification or erroneous behavior in a ML model.

According to the present disclosure, the neural network 104 utilizes a variational neural network 106 and a transformation neural network 108 to generate the robust transformation 110 of the input data 102. In an example, the variational neural network 106 and the transformation neural network 108 are also neural networks, for example, a subset or a part of an entire architecture of the neural network 104. In particular, each of the variational neural network 106 and the transformation neural network 108 may represent a modular component of the overall architecture of the neural network 104. For example, each of the variational neural network 106 and the transformation neural network 108 may have specific functionalities or characteristics associated with an operation of the neural network 104.

The AI system or the neural network 104 of the present disclosure applies randomized embedding smoothing to generate or output the robust transformation 110 of the input data 102. Such robust transformation 110 may be used by the neural network 104 to develop defense against adversarial attacks by learning noise and malicious features to identify or prevent adversarial attacks.

In an example, the neural network 104 may be used for anomaly detection in images that may receive image(s) as the input data 102. In another example, the neural network 104 may be used for log data anomaly detection that may receive discrete input as the input data 102. For example, the discrete input may be categorical variables and/or tokens.

In operation, the variational neural network 106 is configured to process the input data 102. The variational neural network 106 is trained with machine learning to produce statistic parameters including a noise level for the input data 102. The noise level refers to an amount of random noise that is added to logits of the variational neural network 106. These noise levels for the input data 102 are drawn from a probability distribution, such as a Gaussian distribution or a Laplacian distribution.

Since the variational neural network 106 is trained on randomized smoothing, the noise level in the input data 102 is a critical hyperparameter that determines a trade-off between accuracy and robustness of the neural network 104 against adversarial attacks. For example, higher noise level increases the uncertainty in predictions, making it more robust against adversarial perturbations but potentially reducing its accuracy on clean data. Conversely, a lower noise level may preserve accuracy on clean data but make it more vulnerable to adversarial attacks.

To this end, the noise level serves as a parameter that controls a smoothness of decision boundaries of the neural network 104 for the input data 102 and influences its resilience to adversarial attacks.

Further, the variational neural network 106 is configured to inject a set of random noises sampled on the probabilistic distribution according to the statistic parameters defined by the variational neural network. The set of random noises may be sampled on the probabilistic distribution of a variance defined by the noise level to produce a set of perturbed input samples. In particular, the set of random noises are sampled or generated according to the probabilistic distribution. This probabilistic distribution defines statistical properties of the random noises, such as their mean, variance, and probability density function. Common distributions used for generating the set of random noises may include, but are not limited to, Gaussian distribution, Laplacian distribution, or uniform distribution. For example, the variance of the probabilistic distribution used to generate the set of random noises is determined by the noise level. The noise level represents a parameter that controls a magnitude or an intensity of random perturbations to be added to the input data 102. A higher noise level corresponds to larger variations in the set of random noises, while a lower noise level corresponds to smaller variations.

In an example, the injected set of random noises are combined with the original input data 102 to produce the set of perturbed input samples. Each perturbed input sample may be obtained by adding a random perturbation sampled from the probabilistic distribution to a corresponding input sample from the original input data 102.

Thereafter, the transformation neural network 108 is configured to process each of the set of perturbed input samples to produce a set of transformations. In particular, each perturbed input sample is further processed and/or transformed to modify or manipulate the perturbed input sample. Subsequently, the set of transformations are produced from the processing of the set of perturbed input samples perturbed based on addition of random noises. The set of transformations represents changes or alterations applied to the set of perturbed input samples during the processing step. Each transformation may involve operations such as filtering, scaling, rotation, translation, or any other operation that modifies the characteristics of the input data 102, particularly, perturbed input samples from the input data 102.

Moreover, the neural network 104 is configured to output a combination of the set of transformations as the robust transformation 110 of the input data 102. The set of transformations obtained from processing each perturbed input sample are combined together, for example, by adding, or averaging. The set of transformations are aggregated or merged to produce the composite robust transformation 110. The robust transformation 110 possesses qualities of robustness against adversarial attacks or other sources of perturbations. The robust transformation 110 may be used to enhance the resilience or defense of a machine learning model, such as the neural network 104, and/or improve a generalization ability.

In this regard, randomized input smoothing is performed such that noise injection and aggregation across multiple samples may curtail an impact of an adversarial input perturbation. Further, the noise level produced by the variational neural network 106 is based on the input data 102, i.e., input-samples. To this end, there exists a statistical dependency between the noise level produced by the variational neural network 106 and the input data 102. Subsequently, sample-wise noise levels are produced for the randomized smoothing of the input samples of the input data 102. In this manner, the statistical dependency between the noise level and the input samples balances accuracy and robustness as a function of the input data 102 to be transformed. This further allows maintaining this balance automatically for different values of the input data 102.

In an example, the transformation neural network 108 is a classifier such that the robust transformation 110 of the input data 102 includes a classification of the input data 102. In this regard, the classifier transformation neural network 108 may be trained to categorize or classify the input data 102 into one or more predefined classes or categories. The transformation neural network 108 may learn a mapping from input features to class labels, such that given new, unseen input data 102, it can accurately predict correct class label(s) for the input data 102. For example, the transformation neural network 108 may be used in tasks, such as binary classification to predict one of two possible classes for each instance of the input data 102, multiclass classification to predict from multiple possible classes for each instance of the input data 102, or multi-label classification to predict multiple labels or categories for each instance of the input data 102. Further, the transformation neural network 108 may be based on logistic regression, decision trees, random forests, support vector machines (SVM), k-nearest neighbors (k-NN), and other neural networks (for example feedforward neural networks, convolutional neural networks for image data, and recurrent neural networks for sequential data).

### Overview of Randomized Smoothing

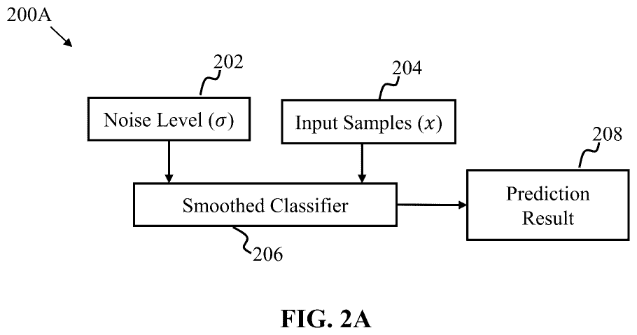

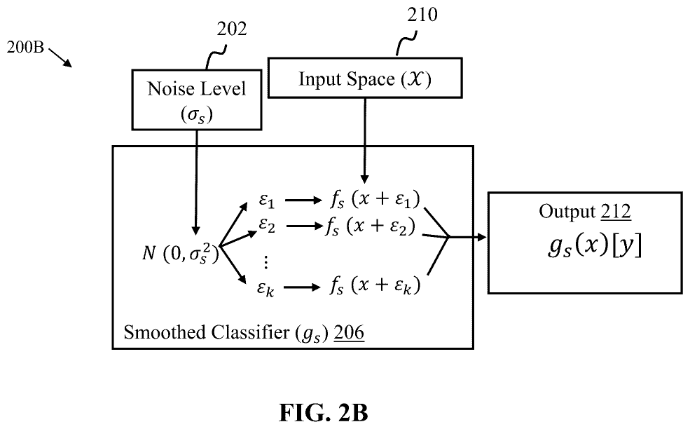

FIG. 2A illustrates a block diagram 200A of a system for performing randomized smoothing, in accordance with some example embodiments of the present disclosure.

Randomized smoothing is a defense mechanism used for adversarial machine learning to improve the robustness of neural networks against adversarial attacks. Randomized smoothing works on the principles of statistical smoothing to enhance resilience to perturbations in an input space.

In randomized smoothing, a prediction result 208 outputs of a neural network, such as a smoothed classifier 206 is perturbed by adding random noise to its logits (pre-softmax outputs). In an example, a random noise level, σ, 202 is determined from a distribution with known properties, such as a Gaussian distribution or a Laplacian distribution. In an example, the random noise level 202 is added to input samples, x, 204. Subsequently, the noise level 202 is introduced to the logits of the smoothed classifier 206 thereby making decision boundaries of the smoothed classifier 206 more uncertain. This may make it more difficult for adversaries to craft effective adversarial examples.

Randomized smoothing is used as a defense mechanism against adversarial attacks because it introduces a level of uncertainty in the prediction result 208 generated by the smoothed classifier 206, which can help mitigate the impact of adversarial perturbations. Even if an adversary crafts a perturbation that leads to misclassification under an original deterministic model, the added randomness in the smoothed classifier 206 may cause the perturbed input to fall into a different class or result in a less confident prediction, reducing the effectiveness of the attack.

The smoothed classifier 206 counteracts perturbation of adversarial examples. The process of randomized smoothing perturbs the input samples 204 with multiple samples of Gaussian noise and aggregates the corresponding outputs of the classifier 206 to produce the prediction result 208. It provides a theoretical certification of robustness that guarantees that the smoothed classifier 206 predicts a correct class, even in the presence of any adversarial perturbations within a certain bound. To this end, all of the input samples 204 are perturbed with the same noise level 202 in the smoothed classifier 206 based on the conventional randomized smoothing to produce the prediction results 208. As a result, the smoothed classifier 206 may fail to achieve a desired balance of accuracy and robustness.

Further, it may be possible to learn a dependency between the noise level 202 and the input samples 204. However, capturing dependencies in a variational manner, i.e., using a neural network to determine sample-wise noise levels, for randomized smoothing may help improve a balance between accuracy and robustness in outputs of a classifier. Subsequently, the embodiments of the present disclosure provide a variation architecture, i.e., the variational neural network 106 for generating sample-wise noise levels for input samples.

### Overview of Practical Randomized Smoothing

FIG. 2B illustrates a schematic diagram 200B for performing randomized smoothing, in accordance with some example embodiments. Randomized smoothing is a defense method applied to a base classifier ƒ: χ→C, where [symbol] ⊆ [symbol] ⊆R is an input space 210. Further, C={1, 2, . . . , M} is a set of class labels. Further, an ideal smoothed classifier 206 is denoted as g: [symbol] →C. The smoothed classifier 206 is defined by choosing a most likely class output of ƒ, when the input space 210 is perturbed by Gaussian noise. To this end, an output 212 of the smoothed classifier 206 is defined as:

$$g ( x ) := \begin{matrix}arg max \\ c ∈ C\end{matrix} ℙ [ f ( x + ε ) = c ] , \qquad ( 1 )$$

where [symbol] [·] denotes a probability with respect to a Gaussian noise ε˜

$$N ( 0 , {σ}_{s}^{2} {I}_{d} )$$

with I_{d} denoting an identity matrix of dimensionality d. This provides certified robustness, by guaranteeing that an output g(x+δ) is constant for any adversarial perturbation δ∈ [symbol] ^{d} within l₂ radius R, i.e., ∥δ∥₂≤R given by:

$$R = \frac{{σ}_{s}}{2} ( {Φ}^{- 1} ( {p}_{a} ) - {Φ}^{- 1} ( {p}_{b} ) ) , \qquad ( 2 )$$

where Φ⁻¹ is the inverse of a standard Gaussian Cumulative Distribution Function (CDF), and pₐ and p_{b} are the probabilities of the two most likely outputs of

$$f ( x + ε ) for ε ∼ N ( 0 , {σ}_{s}^{2} {I}_{d} ) .$$

Further, as the calculation of the ideal smoothed classifier 206 in the Eq. (1) is generally intractable, a Monte-Carlo approximation may be utilized. The smoothed classifier 206 is modified to approximate a value for the Eq. (1) by taking a majority vote over N samples of Gaussian noise, as given by

$$g ( x ) \approx \begin{matrix}arg max \\ c ∈ C\end{matrix} {\sum }_{k = 1}^{N} 𝕀 [ f ( x + {ε}_{κ} ) = c ] , \qquad ( 3 )$$

Where [symbol] [·] denotes a binary indicator function and the Gaussian noise samples are denoted by

$${ε}_{k} \begin{matrix}iid \\ ∼\end{matrix} N ( 0 , {σ}_{s}^{2} {I}_{d} ) for k ∈ \{ 1 , 2 , … , N \} .$$

For example, the smoothed classifier 206 may be abstained from making a prediction, if statistical confidence is not satisfied during certification. Based on the ideal certified radius, given in Eq. (2), a practical certified guarantee is provided by estimating bounds on pₐ and p_{b} for a given confidence level a, based on statistical tests applied to the outputs ƒ(x+εₖ) over the N samples of Gaussian noises. Given a confident lower bound pₐ on a probability pₐ, an upper bound is given by P_{b}≤1−pₐ pa. Thus, certified radius approximation is given by:

$$R {\approx }^{>} \frac{{σ}_{s}}{2} ( {Φ}^{- 1} ( \underline{{p}_{a}} ) - {Φ}^{- 1} ( \underline{{p}_{b}} ) ) = {σ}_{s} {Φ}^{- 1} ( \underline{{p}_{a}} ) \qquad ( 4 )$$

Some embodiments of the present disclosure are based on a realization that an effective and a common technique to enhance a performance of the randomized smoothing is to train the classifier 206, ƒ, with Gaussian noise augmentation, in order to adapt to the Gaussian noise employed in this defense. Pursuant to the present disclosure, σₐ is used to denote a standard deviation of the Gaussian noise used for training augmentation. Hence, with this augmentation, randomized smoothing involves two noise level parameters 202, namely, σₛ and σₐ. The noise levels 202 σₛ and σₐ impact performances of certified accuracy and radius. In particular, a selection of the noise levels 202 σₛ and σₐ yields a trade-off, and thus it is often difficult to maximize both accuracy and radius together.

To this end, for any value of noise levels 202 σₛ and σₐ that may be a trade-off between certified accuracy and radius or robustness. In an example, the reason for the trade-off may be explained by a relationship between prediction accuracy and noise level, σₛ. It is expected that the classifier 206 would have higher accuracy for smaller σₛ, which corresponds to increasing the value of Φ⁻¹( [symbol] ₐ) in the Eq. (4). However, the certified radius given by the Eq. (4) is also proportional to σₛ. Hence, realizing an optimal certified radius, R, requires a balance between these values, and the ideal selection of the noise levels, σₛ and σₐ is intractable. The embodiments of the present disclosure address the above-mentioned challenges by introducing variational randomized smoothing and generalized training methods.

### Overview of Variational Randomized Smoothing

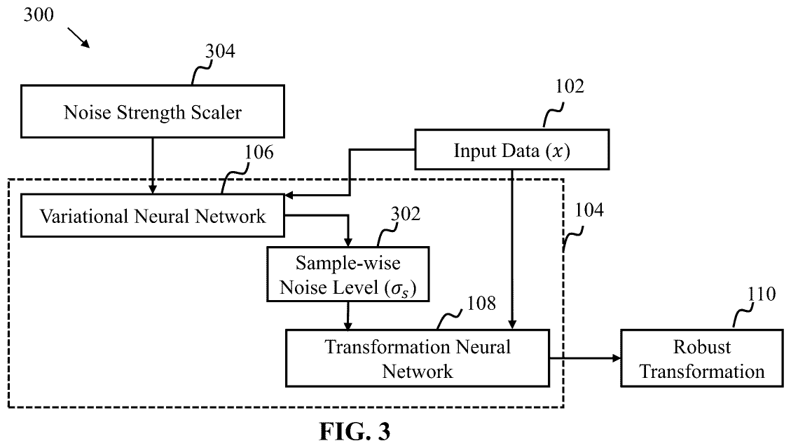

FIG. 3 illustrates a block diagram 300 of a system for performing variational randomized smoothing using the neural network 104, in accordance with some example embodiments of the present disclosure.

The neural network 104 disclosed in the present disclosure includes a noise level selector that is implemented using a neural network. This noise level selector, referred to as the variational neural network 106, enables a smoothed classifier to use a noise level, a, suitably selected for each input sample, x, to improve prediction results.

The system is configured to receive the input data 102. Such input data may be received from various sources depending on a nature of a task and a domain of the neural network 104. Some common sources of input may include, but are not limited to, images, videos, sensor readings, time-series data, audio signals, categorial features, ordinal features, count data, text data, sparse data representations, binary features, symbolical data, and event-based data.

In an example, the input data 102 may be received from categorical features. For example, datasets including categorical features may include discrete variables that represent categories or groups. These variables may include attributes such as gender, ethnicity, product type, customer segment, etc. The neural network 104 may receive discrete input samples directly from the categorical features encoded as numerical values or one-hot encoded vectors.

In another example, the input data 102 may be received from pixels of images. For example, datasets including pixel value of each pixel in an image may be considered as continuous data that represent intensity or color of each pixel. The pixel value may vary continuously within a certain range, such as grayscale values ranging from 0 to 255 or RGB values ranging from 0 to 1. The neural network 104 may receive pixel values of image(s) directly from the image(s) or one-hot encoded vectors.

According to embodiments of the present disclosure, the neural network 104 for generating robust transformation 110 of the input data 102 comprises of the variational neural network 106 and the transformation neural network 108.

The variational neural network (VNN) 106 has a type of neural network architecture that incorporates variational inference techniques. Variational inference is a method used in Bayesian statistics and machine learning to approximate complex probability distributions, which are often intractable to compute directly.

In the VNN 106, model parameters are treated as random variables with associated probability distributions. A goal of the VNN 106 is to infer a posterior distribution of these parameters given an observed data. However, instead of computing an exact posterior distribution, which is often computationally infeasible, variational inference seeks to approximate it with a simpler, parameterized distribution that is easier to work with. In this regard, the VNN 106 may introduce additional latent variables, often referred to as “variational parameters,” that capture uncertainty in the model parameters. These latent variables are optimized alongside the model parameters during training to minimize any discrepancy between the exact posterior distribution and an approximate distribution.

Pursuant to embodiments of the present disclosure, the VNN 106 may be implemented using a meta-learning technique. The meta-VNN may generally or universally learn a variational inference algorithm without specifying regularization parameters. The universal meta learning is realized by stochastically drawing different regularization parameters. By applying a form of regularization that varies dynamically throughout a learning or training process, randomness is introduced into the regularization process. This stochastic regularization technique enables the meta VNN model to perform universally well across a wide range of different settings of regularization parameters.

Accordingly, by using the VNN 106 based on the universal or generalized meta-learning, diversity is introduced into the regularization applied to the VNN 106. This diversity may encourage the VNN 106 to learn more robust and generalizable representations of data, such as noise levels for input data. Further,

training efficiency of the VNN 106 may be improved by avoiding a requirement of learning multiple VNN models at different conditions using the generalized meta-learning.

In an example, random sampling of the regularization parameters is based on uniform distribution or non-uniform distribution according to an assumption of an importance range of regularization values. Regularization parameters are parameters that control a strength of regularization applied to the VNN 106 during training, such as the weight decay coefficient in L2 regularization or the dropout rate in dropout regularization. To this end, the regularization parameters for the regularization of the VNN 106 may be randomly selecting or randomly sampled from uniform distribution (i.e., all values within a specified range have an equal probability of being selected) or a non-uniform distribution (i.e., probability of selecting different values may vary according to some predefined distribution). Moreover, the randomly sampled regularization parameters are weighted or biased to further encourage the importance range of regularization values. For example, the assumption about the importance range of regularization values may reflect a belief that certain ranges of regularization values may be more effective or relevant for achieving good performance on the given task or dataset. This introduces randomness into the regularization process and allows use of different regularization settings to find a most effective configuration for the VNN 106.

The transformation neural network 108 is a deep neural network trained for one or a combination of: automatic speech recognition, anomaly detection, language modelling, image classification, and log data modelling. For example, the transformation neural network 108 may be a convolution-based or transformer-based model having the ability to capture long-range dependencies and contextual information effectively. The transformation neural network 108 may be used for performing several tasks, such as modifying input, i.e., a set of perturbed input samples, to draw conclusions and/or generate outputs. Examples of the tasks that may be performed by the transformation neural network 108 may include, but are not limited to, image classification, object detection, feature extraction, semantic segmentation, language modeling, machine translation, speech recognition, text generation, question answering, text classification, temporal network analysis, named entity recognition, and summarization.

According to the present disclosure, the VNN 106 is configured to process the input data 102 to perform a variational randomized smoothing. Accordingly, the VNN 106 is configured to select a suitable sample-wise noise levels, σₛ, 302 for each input sample (such as each input image) in the input data 102. The VNN 106, denoted as: h: X→[0, ∞), is used to select randomized smoothing noise levels 302 as a function of corresponding each input sample, x. This is denoted as σₛ=h(x). Further, the transformation neural network 108 denoted as gᵥ, may be similar to the smoothed classifier 206, that employs the sample-wise noise levels 302 produced by the VNN 106 to generate perturbed input samples, i.e., introduce noise to the input samples.

In an example, the VNN 106 accepts a noise strength scaler 304 as a parameter to adjust a strength of the sample-wise noise levels 302 based on the noise strength scaler 304. The noise strength scaler 304 is a parameter or a factor used to adjust a strength, or an intensity of a noise added to data or model parameters. In this regard, the noise strength scaler 304 may be accepted as a parameter to modify or change a random noise to be allocated to an input sample and to produce sample-wise noise level for a particular input sample. For example, based on a change in the noise strength scaler 304, sample-wise noise levels 302 for each of or a few of the input samples may be modified. In an example, a value of the noise strength scaler 304 is accepted from a user interface. In other words, a user interacting with the user interface may provide the value for the parameter noise strength scaler 304 as an input to the system. The received value may be used to produce or modify sample-wise noise-levels 302 for the input samples of the input data 102.

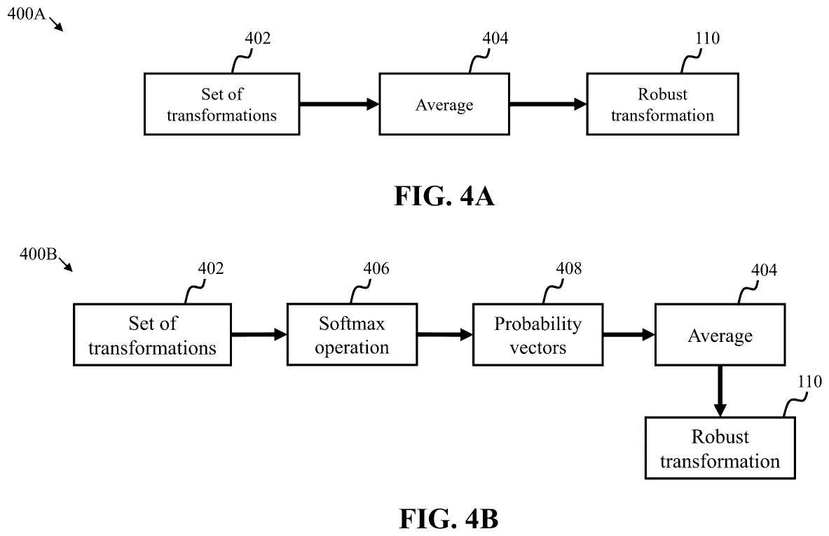

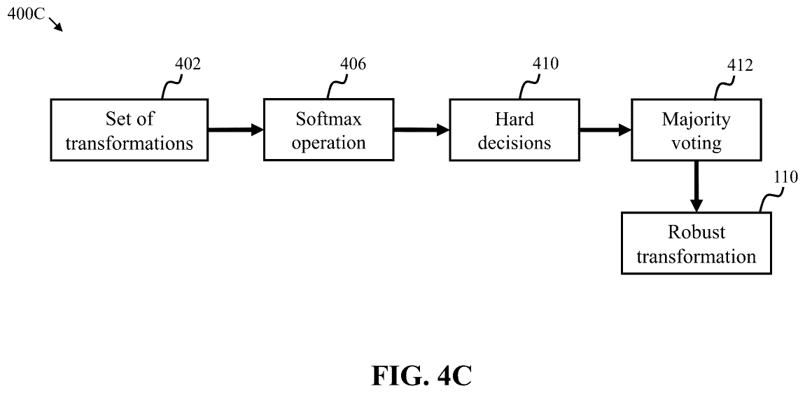

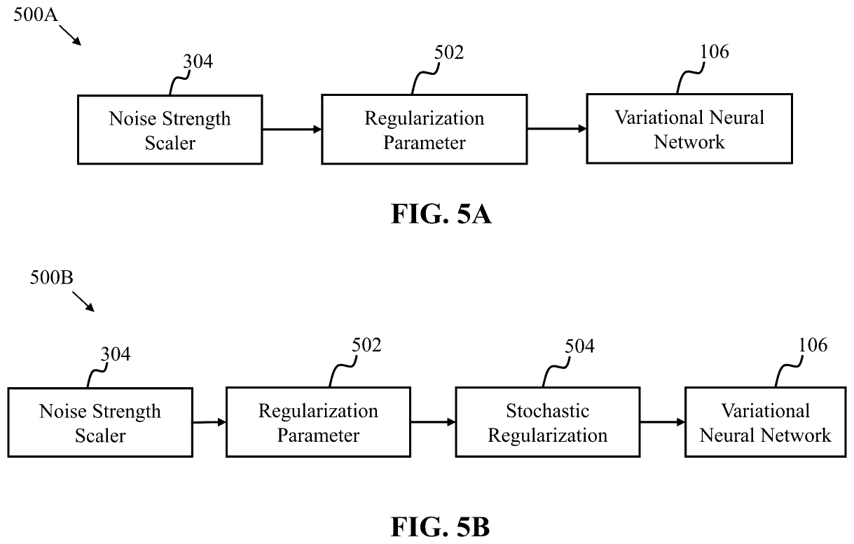

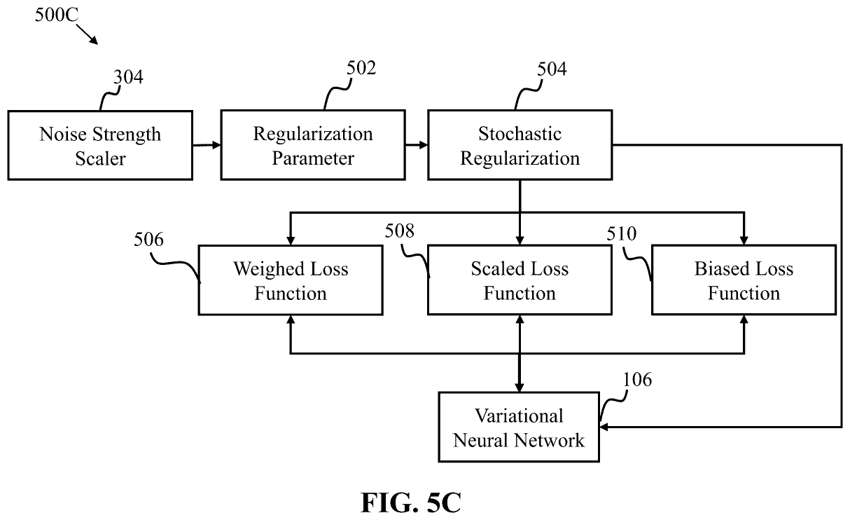

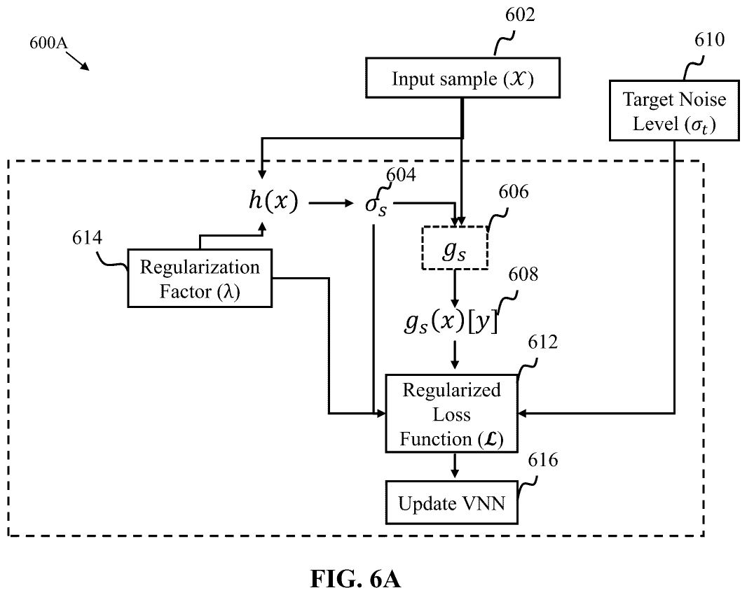

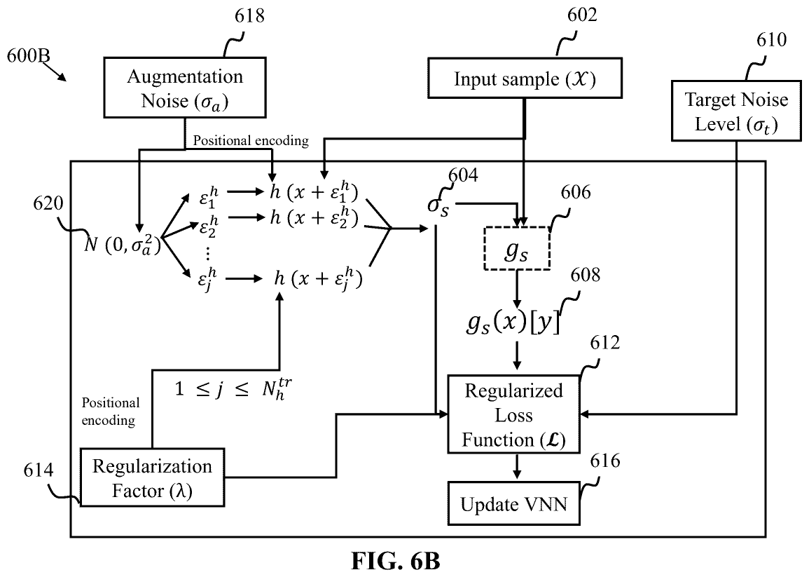

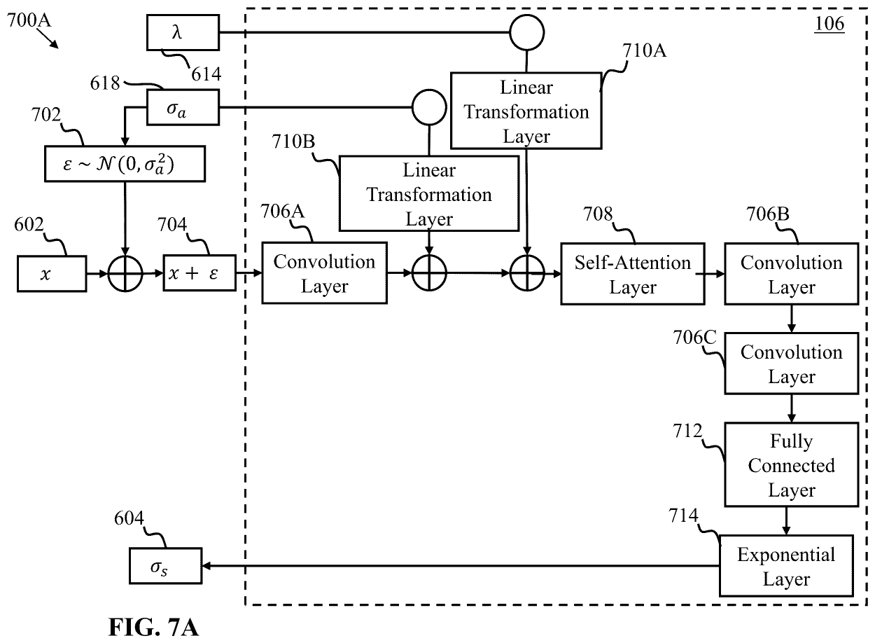

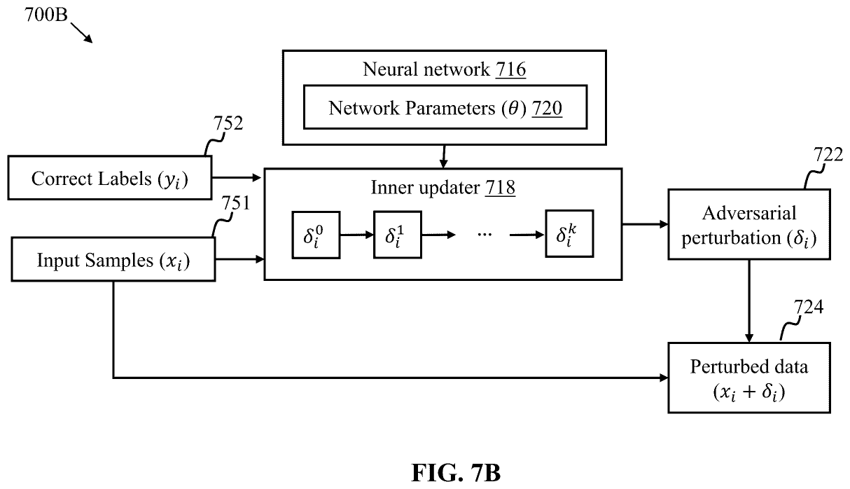

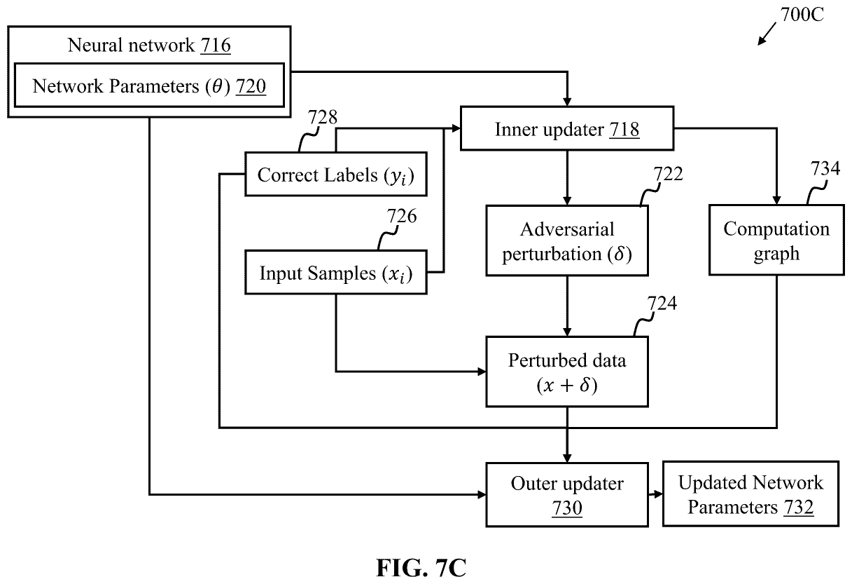

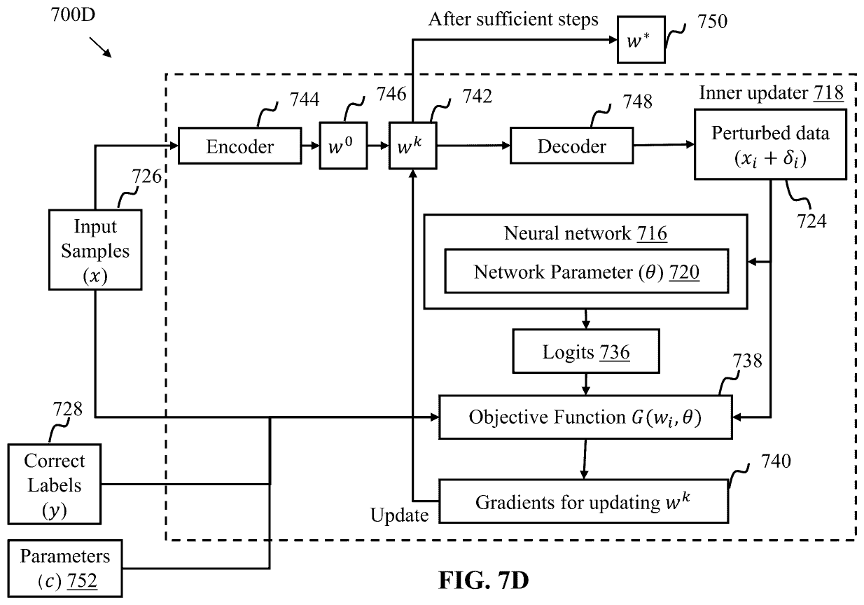

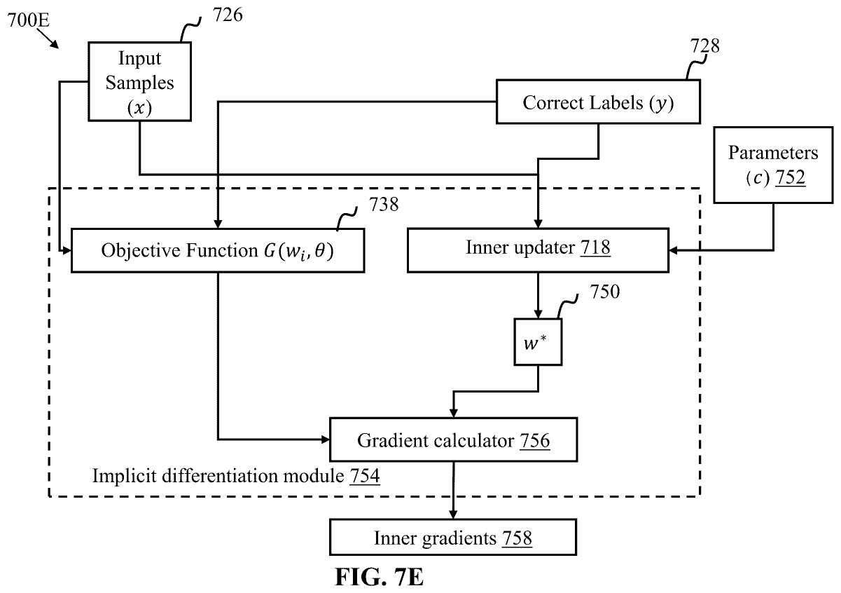

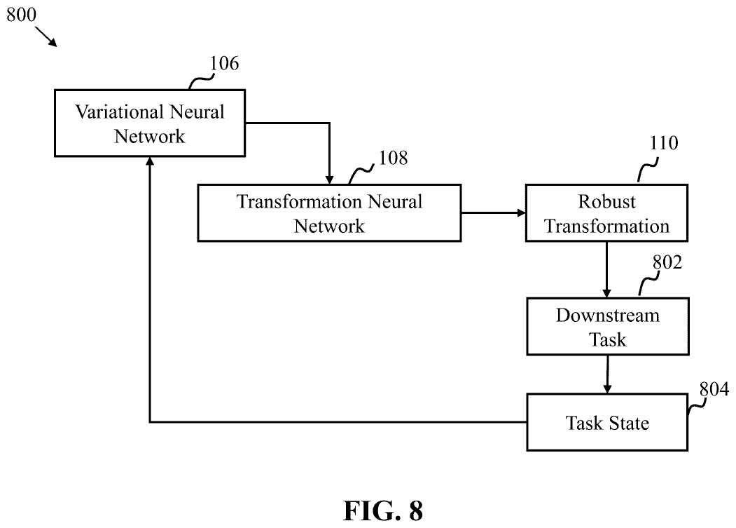

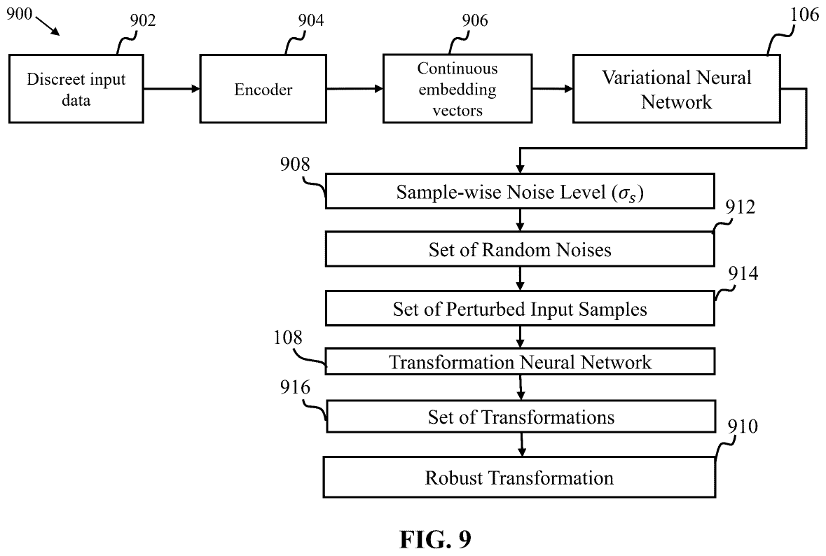

Details of the VNN 106 are further described in conjunction with, for example, FIG. 4A, FIG. 4B, FIG. 4C, FIG. 5A, FIG. 5B, FIG. 5C, FIG. 6A, FIG. 6B, FIG. 7A, FIG. 8, and FIG. 9.

To this end, the VNN 106 is configured to inject the random sample-wise noise levels 302 into the corresponding input sample from the input data 102 to produce a set of perturbed input samples. In one example, the random sample-wise noise levels 302 may be gaussian noise sampled from a normal distribution. Further, a magnitude of the gaussian noise may be controlled or adjusted to the predetermined magnitude by adjusting a variance or a standard deviation of the normal distribution. Such gaussian noise introduces random perturbations to the input samples. In another example, the random sample-wise noise levels 302 may be random perturbations that may be added to vectors of the input samples by adding small, random offsets to each dimension of the vectors.

In certain cases, the random sample-wise noise levels 302 may be added or injected to the input samples using dropout regularization, data augmentation, or gradient masking. For example, the dropout regularization may cause to set certain values of image in vectors to zero, effectively introducing noise. Moreover, the data augmentation may introduce random transformations to the vectors of the input samples by, for example, rotations, translations, or scaling. In addition, the gradient masking intentionally masks or manipulates gradients of the vectors of the input samples.

The injection of the random sample-wise noise levels 302 may modify the input samples in a way that makes each input sample slightly different from their original representations while having a dependency between a noise level and the corresponding input sample. This allows the set of perturbed input samples to defend against an adversarial input attack by essentially drowning those small adversarial perturbations with random noise.

In an example, the random sample-wise noise levels 302 are a set of random noises injected into the input data 102 to produce the set of perturbed input samples. In an example, the set of random noises may be sampled on a Gaussian distribution. Subsequently, the set of random noises includes a set of Gaussian noise tensors. The Gaussian noise tensors refer to multi-dimensional arrays (tensors) filled with random values sampled from a Gaussian (or normal) distribution. These tensors are used to introduce controlled randomness or perturbations. The Gaussian noise tensors are characterized by its mean (p) and standard deviation (σ), where a probability density function follows a normal distribution. In an example, each of the set of Gaussian noise tensors includes independent Gaussian samples having a mean of zero and a standard deviation defined by the noise level. The noise level is produced by the VNN 106 based on the input data 102.

For example, each of the set of Gaussian noise tensors has a shape of a tensor of floating-point values. The set of Gaussian noise tensors may be filled with random numbers drawn from a Gaussian (or normal) distribution. Moreover, the shape of the tensor is specified by its dimensions. For example, for image data, the tensor shape may be defined as (batch_size, channels, height, width). The elements in the tensor are floating-point numbers (e.g., 32-bit float or 64-bit float fractions and very small or very large numbers), allowing for precise representation of the random noise values.

To this end, each of the perturbed input samples is formed by adding the tensor of floating-point values to features of the input data 102. For example, the tensor of floating-point values is based on the noise level produced by the VNN 106. Subsequently, the floating-point values of the tensors may be added to the input data 102 to generate the perturbed input samples that have precise representations.

The transformation neural network 108 is configured to process each of the set of perturbed input samples to produce a set of transformations. It may be noted, the set of perturbed input samples refers to embeddings that have been intentionally modified or distorted from their original representations. The modifications are introduced as a form of the random sample-wise noise levels 302.

To this end, the set of perturbed input samples may be transformed into the set of transformations based on a transformation task associated with the transformation neural network 108. The transformation task may indicate a function or a type of transformation to be performed on the set of perturbed input samples in order to carry out a task associated with the transformation neural network 108 or the neural network 104.

Further, the system 102 is configured to output a combination of the set of transformations as the robust transformation 110 of the input data 102. In an example, the combination of the set of transformations is an aggregation of the set of transformations. In another example, randomly selected transformations from the set of transformations may be aggregated to generate the output. The output may be the robust transformation 110 that may form the defense of the neural network 104 and enable the neural network 104 to provide robust output, i.e., perform tasks accurately even with slight perturbations. For example, for an anomaly detection-based neural network 104, the neural network 104 robustly or reliably detects anomaly even when perturbed input may be provided.

Details of techniques used for combining the set of transformations to produce the robust transformation 110 are described in conjunction with FIG. 4A, FIG. 4B and FIG. 4C.

Overview of Producing Robust Transformation from a Set of Transformations

FIG. 4A is a schematic diagram 400A of aggregation of a set of transformations 402, according to some example embodiments. FIG. 4A is explained in conjunction with FIG. 1 and FIG. 3.

In particular, an aggregation method may be used to aggregate the set of transformations 402 to produce the final robust transformation 110. According to the present example, the aggregation method may correspond to computing an average 404 for the set of transformations 402. For example, each of the set of transformations 402, Y₁, . . . , Yₖ, may include a continuous tensor. Further, the final output or the robust transformation 110, Y, may be the robust transformation of the input data 102. The robust transformation 110 may be determined as the average 404 of the set of transformations 402.

FIG. 4B is a schematic diagram 400B of aggregation of the set of transformations 402, according to some example embodiments. FIG. 4B is explained in conjunction with FIG. 1, FIG. 3, and FIG. 4A.

In particular, an aggregation method may be used to aggregate the set of transformations 402 to produce the final robust transformation 110.

The present example is based on a recognition that each of the set of transformations 402 may be a tensor of one or more vectors of logits. The logits may be raw and unnormalized predictions produced by the transformation neural network 108 before applying any activation function. Logits may be an output of a last layer, such as an output layer of the transformation neural network 108, just before passing through the activation function. In an example, each transformation, Yᵢ, of the set of transformations 402, Y₁, . . . , Yₖ, is a tensor of one or more vectors of logits, i.e., unnormalized log-likelihoods.

In an example, given a set of logits z=z₁, z₂, . . . , zₙ, where n is a number of classes, a probability vector of each class i may be calculated using a Softmax operation 406 as:

$$P ( {y}_{i} ) = \frac{{e}^{{z}_{i}}}{{\sum }_{j = 1}^{n} {e}^{{z}_{j}}}$$

where:
zᵢ is a logit corresponding to class i, P(yᵢ) is the probability vector of class i, and
e is Euler's number.

In operation, the transformation neural network 108 may be configured to convert tensor of each of the one or more vectors of logits of the set of transformations 402 into a probability vector via the softmax operation 406 to produce a set of probability vectors 408. The one or more vectors of logits may be a collection of vectors for each of the set of transformations 402 of the input data 102. The vectors of logits may be used to compute the set of probability vectors 408 for the set of transformations 402 in parallel using the softmax operation 406. For example, each logit vector of the set of transformations 402 is converted into a probability vector via the softmax operation 406. Pursuant to present example, the softmax operation 406 may exponentiate each term and normalize across each vector such that a vector sum that is equal to one, i.e., a probability distribution over the vectors of the set of transformations 402.

Thereafter, the set of transformations 402 may be aggregated by computing an average 404 of the set of probability vectors 408 in a probability space. In an example, the aggregation method may be utilized to compute the average 404 of the set of probability vectors 408 in the probability space. In this manner, the set of probability vectors 408 are aggregated by averaging 404 to produce an average probability vector. For example, the averaging 404 is performed across the probability distribution of the vectors of logits of the set of transformations 402 or the set of probability vectors 408.

Further, the average probability vector may be converted with log-likelihoods to produce the robust transformation 110 of the input data 102. Subsequently, the robust transformation 110 of the input data 102 is determined using the average probability vector.

FIG. 4C is a schematic diagram 400C of aggregation of the set of transformations 402, according to some example embodiments. FIG. 4C is explained in conjunction with FIG. 1, FIG. 3, FIG. 4A and FIG. 4B.

In an example, a transformation performed by the transformation neural network 108 may converting each of the one or more vectors logits into a hard decision by selecting an index of a largest logit value to produce a set of hard decisions. In this regard, each transformation, Yᵢ, of the set of transformations 402 may be a tensor of one or more vectors of logits or probabilities. Further, an aggregation method may be based on hard decisions. The hard decisions refer to a process of selecting a vector with a highest probability as a predicted vector for aggregation. To this end, the set of hard decisions corresponding to the set of transformations 402 may be aggregated to produce the robust transformation 110 of the input data 102.

In an embodiment, each of the one or more vectors of logits may be converted into a hard decision by selecting an index of a largest logit value to produce a set of hard decisions 410. In particular, after applying the softmax operation 406 to the vectors of the logits, i.e., raw predictions or outputs produced by the transformation neural network 108, a probability distribution over the vectors is generated. The probability distribution may include the set of probability vectors 408 in a probability space, where each vector is assigned a probability score between 0 and 1. To generate the set of hard decisions 410, the vector with the highest probability or logit value is chosen as the predicted vector. In an example, each vector of the logits of the set of transformations 402 may be converted to a hard decision to generate the set of hard decisions 410 by taking the index of the maximum logits value, such as by applying argmax operation in each logit or the set of probability vectors 408.

Thereafter, the set of hard decisions 410 may be aggregated to produce the robust transformation 110 of the input data 102. In this regard, the aggregation method may involve aggregating the set of hard decisions 410 across the samples by taking a mode, i.e., majority voting 412 across each of the set of hard decisions 410 to produce the final model output or the robust transformation 110, Y, for the input data 102.

### Overview of Training for Variation Randomized Smoothing

FIG. 5A depicts a schematic diagram 500A of training of the VNN 106 to produce a noise level for the input data 102, in accordance with some example embodiments of the present disclosure. FIG. 5A is described in conjunction with FIG. 1, FIG. 3, FIG. 4A, FIG. 4B and FIG. 4C.

Pursuant to the present disclosure, the variational neural network 106 is a single model trained for different values of the noise strength scaler 304 used as a regularization parameter 502. In particular, the training of the VNN 106 is dependent on model's architecture, training data, and regularization techniques.

Regularization parameters refer to hyperparameters used to control an amount of regularization applied to the VNN 106 during training. Regularization is a technique that is used to prevent overfitting, which occurs when a model learns to memorize the training data rather than generalize well to unseen data. For example, the regularization parameters 502 for the VNN 106 may be based on different regularization techniques. Examples of different regularization techniques may include, but are not limited to, L1 or Lasso regularization, L2 or Ridge regularization, elastic net regularization, Dropout regularization, and weight decay regularization.

These regularization parameters 502 play a crucial role in controlling a trade-off between accuracy and generalization or robustness ability. By tuning these regularization parameters 502, desired level of randomness may be added to the input data 102. Hoin an example, in order to find optimal values for the regularization parameters 502 cross-validation techniques may be used.

To this end, the noise strength scaler 304 enables to modulate an intensity of noise injected into the VNN 106 during training. By varying the regularization parameter associated with the noise strength scaler 304 across different values, the impact of the different values in regularization on the performance and the robustness of the VNN 106 may be judged/tested.

In an example, during training, the VNN 106 learns to adapt its internal representations and decision boundaries in response to the injected noise. A higher value of the noise strength scaler 304 corresponds to more aggressive regularization, encouraging the VNN 106 to learn simpler, more generalizable patterns in data while suppressing overfitting. On the other hand, a lower value of the noise strength scaler 304 allows the VNN 106 to focus more on capturing fine-grained details in the input data 102, potentially leading to better performance on training dataset but with a higher risk of overfitting.

By training the VNN 106 on different values of the noise strength scaler 304, the trade-offs between complexity, generalization ability, and robustness against noise and perturbations in the input data may be assessed. This enables to fine-tune the regularization strategy to form a balance between model capacity and regularization strength.

FIG. 5B depicts a schematic diagram 500B of training of the VNN 106 to produce a noise level for the input data 102, in accordance with some example embodiments of the present disclosure. FIG. 5B is described in conjunction with FIG. 1, FIG. 3, FIG. 4A, FIG. 4B, FIG. 4C, and FIG. 5A.

In an example, the VNN 106 is trained with a stochastic regularization 504 to produce the noise level of different strengths by randomly sampling the regularization parameter 502 according to a random distribution.

Stochastic regularization is further configured to introduce randomness into the regularization process, resulting in a more robust and generalizable VNN 106. In particular, the VNN 106 is trained to produce noise levels for the input data 102, specifically a noise level for each sample in the input data 102. Subsequently, during the training, the VNN 106 is trained to produce noise levels of different strengths using the stochastic regularization 504. In this regard, the regularization parameter 402 associated with the noise strength scaler 304 is randomly sampled from a probability distribution. This allows for the generation of noise with varying intensities, effectively tuning the strength of regularization applied during training.

By randomly sampling the regularization parameter 502 according to a random distribution, further diversity is introduced into the regularization process. This VNN 106 explores different levels of regularization during training, allowing it to adapt to a wide range of data patterns and characteristics. Additionally, the use of a random distribution ensures that the regularization strength is not fixed but rather varies dynamically across different iterations of the training process.

In an example, a probability distribution used for sampling the regularization parameter 502 may include, but is not limited to, uniform distribution, Gaussian distribution, or exponential distribution. To this end, the stochastic regularization 504 with randomly sampled regularization parameter 502 provides introduces randomness in generating the sample-wise noise levels 302 for the input data and for controlling a strength of regularization in the VNN 106. By introducing randomness into the regularization process, the VNN 106 learns more robust and adaptable representations, ultimately improving its performance on unseen data.

FIG. 5C depicts schematic diagram 500C of training of the VNN 106 to produce a noise level for the input data 102, in accordance with some example embodiments of the present disclosure. FIG. 5C is described in conjunction with FIG. 1, FIG. 3, FIG. 4A, FIG. 4B, FIG. 4C, FIG. 5A, and FIG. 5B.

In an example, the VNN 106 is trained with a weighted loss function, a scaled loss function, and a biased loss function according to the value of the randomly sampled regularization parameter 502. For example, the regularization parameter 502 is associated with the noise strength scaler 304. The regularization parameter 502 may be randomly sampled according to a random distribution, such as Gaussian distribution. Further, the stochastic regularization 504 is applied to the sampling of the regularization parameter 502 to produce the noise level of different strengths for each of different input samples of the input data 102.

It may be noted that the input data 102 is described as training data with respect to the FIG. 5A, FIG. 5B and FIG. 5C. However, this should not be construed as a limitation. The input data may also correspond to input during an inference phase, as described in conjunction with FIG. 6, FIG. 7A, and FIG. 8.

Returning to the present example, the weighted loss function 506 refers to a modification of a standard loss function, where different data points are assigned different weights. Further, contributions of individual data points to the overall loss are adjusted based on their importance or significance. For example, in imbalanced classification tasks where one class is rare compared to others, the loss function may be weighted to give more importance to the rare class, ensuring that a model pays more attention to correctly predicting instances of the rare class. Alternatively, in the training of the VNN 106, certain input samples with higher importance may have a higher weight value allocated to provide more emphasis in loss function of these input samples. This may address class imbalance and sample heterogeneity in the input data 102 or training dataset.

Further, the scaled loss function 508 refers to a loss function that is multiplied by a scaling factor or coefficient. The scaling factor is applied to adjust a magnitude of a loss, thereby controlling its influence on the optimization process. For example, the scaled loss function 508 may be used to fine-tune the learning process or meta-learning of the VNN 106 to balance the contributions of different components of the loss. For example, in multi-task learning settings where multiple loss terms for different input samples are combined, each loss term may be scaled differently to balance their relative importance.

Continuing further, the biased loss function 510 refers to a loss function that introduces bias into the optimization process. Such bias may arise from various sources, such as a choice of loss function itself, a data distribution, or one or more modeling assumptions. The biased loss function 510 may prioritize certain types of errors over others, leading to systematic errors or inaccuracies in the predictions of the VNN 106.

In certain cases, other loss functions, such as cross entropy (CE) loss and a Kullback-Leibler (KL) divergence are also calculated for the VNN 106. These loss functions are minimized by using a regularized loss function combining the CE loss and the KL divergence.

To this end, an output or prediction of noise level for input samples are assessed with respect to a desired level of randomness to be added or a decision boundary of the neural network 102 after each epoch of the processing of the input data 102. Based on the output of the first epoch, the loss functions, including the weighted loss function 506, the scaled loss function 508 and the biased loss function 510 are determined or calculated. These loss functions are further used to adjust weights of the VNN 106 to produce improved noise levels that have a dependency with the input samples of the input data 102.

Further details of the training of the VNN for performing variational randomized smoothing and multi-stage variational randomized smoothing are described in conjunction with FIGS. 6A and 6B.

FIG. 6A illustrates a schematic diagram 600A of training of the VNN 106 for variational randomized smoothing, in accordance with some example embodiments of the present disclosure. FIG. 6A is described in conjunction with FIG. 1, FIG. 3, FIG. 4A, FIG. 4B, FIG. 4C, FIG. 5A, FIG. 5B and FIG. 5C.

Embodiments of the present disclosure disclose variational randomized smoothing technique to select a suitable noise level, σₛ, 604 for each input sample, such as each input image of the input data 102. In this regard, an additional neural network or the VNN 106 is used to select a randomize smoothing noise level as a function of each input sample, x, 602. The VNN 106 is defined by: h: X→[0, ∞). In this regard, a noise level, σₛ, 604 for the input sample, x, 602 may be selected as: σₛ=h(x). Noise levels may be injected into the input sample 602 to produce perturbed input sample. Further, gᵥ is used to denote a neural network or a classifier employing or using the noise level selector or the VNN 106, h. Subsequently, gᵥ corresponds to the neural network 104.

For example, majority voting of the smoothed classifier defined by the Eq. (3) is not differentiable, which prevents the training of the VNN 106 for sample-wise noise level generation. Thus, for training purposes, the transformation neural network 108 based on a soft smoothed classifier, gₛ, 606 is used. The perturbed input sample produced by the VNN 106 may be processed by the smoothed classifier, gₛ, 606, or the transformation neural network 108 to produce a transformation. The transformation may be a tensor of one or more vectors of logits. The classifier, gₛ, 606 aggregates soft outputs of the VNN 106, h, as given by:

$${g}_{s} ( x ) := \frac{1}{{N}_{f}^{tr}} {\sum }_{k = 1}^{{N}_{f}^{tr}} soft max ( \frac{{f}_{s} ( x + {ε}_{k} )}{τ} ) , \qquad ( 5 )$$

Where ƒₛ denotes a soft logit vector output of the transformation neural network or the base classifier

$$f , {ε}_{k} \begin{matrix}iid \\ ∼\end{matrix} N ( 0 , {σ}_{s}^{2} {I}_{d} ) . {N}_{f}^{tr}$$

are samples of Gaussian noise with σₛ=h(x) and τ>0 is a tempering factor for a tempered softmax operation. In this regard, each of the one or more vectors of logits are converted into a probability vector using the tempered softmax operation with the tempering factor to produce a set of probability vectors. For example, the tempering factor may be set as τ=1 for simplicity. Further, when τ→0, the soft smoothing is equivalent to a standard majority voting used in the Eq. (3). In an example, the set of probability vectors may be averaged 404 in a probability space to produce an average probability vector. Subsequently, the robust transformation of the input sample 602 is determined using the average probability vector.

Further, to train the VNN 106 to select the noise level, σₛ, 604 as a function of the input sample, x, 602 for better accuracy, a typical objective of minimizing CE loss and KL divergence is utilized. The CE loss may be defined as:

$${ℒ}_{CE} ( x , y ) = - log {g}_{s} ( x ) [ y ] ,$$

where y denotes a correct class label for x and gₛ (x)[y] denotes a corresponding class likelihood 608 output by gₛ. In this regard, the average probability vector is converted with log-likelihoods to produce the robust transformation of the input sample, x, 602.

However, minimizing only the CE loss might result in degraded robustness against adversarial attacks as it encourages smaller vales of sample-wise noise levels, σₛ. Therefore, to maintain a reasonable value for noise level, σₛ, 604, an additional regularization term is introduced to regularize noise level, σₛ, 604 towards a desired distribution.

In an example, a distribution of a perturbation E may be conditionally Gaussian given

$${σ}_{s} as ε ∼ N ( 0 , {σ}_{s}^{2} {I}_{d} ) .$$

To this end, the distribution may not remain marginally Gaussian as σₛ=h(x) changes for different input samples, x. To encourage Gaussianity of the marginal distribution, the VNN 106 having variational framework based on the KL divergence is employed to control a distribution of σₛ. For example, by setting a target Gaussian distribution for ε to be

$$q = N ( 0 , {σ}_{t}^{2} {I}_{d} ) ,$$

a target noise level, σₜ, 610 is captured at the KL divergence. The KL divergence, represented as D_{KL}(p∥q), to regulate a distribution of

$$p = N ( 0 , {σ}_{s}^{2} {I}_{d} )$$

is given by:

$${D}_{KL} ( p ‖ q ) = d [ \frac{1}{2} {( \frac{{σ}_{s}}{{σ}_{t}} )}^{2} - \frac{1}{2} - log ( \frac{{σ}_{s}}{{σ}_{t}} ) ] \qquad ( 6 )$$

To train the VNN 106, a regularized loss function, L, 612 is used that combines the CE loss and KL divergence. Subsequently, the regularized loss function, [symbol] , 612 is defined as:

$$ℒ = ( 1 - λ ) {ℒ}_{CE} ( x , y ) + λ {D}_{KL} ( p ‖ q ) , \qquad ( 7 )$$

where λ ∈[0, 1] is a regularization parameter 614 used for adjusting a contribution of each loss term. With smaller λ, the clean data accuracy may be better, while higher robustness may be achieved for higher values of λ that encourages the noise level, νₛ, produced by the VNN 106 to be closer to the target noise level, σₜ, 610.

Some embodiments are based on a realization that the regularization parameter 614 may control a strength of a first loss term, i.e., the CE loss, and a second loss term, i.e., KL divergence. However, it may be cumbersome to select a prover value for the regularization parameter 614 for training.

Thus, embodiments of the present disclosure describe a generalized training process using a stochastic regularization, which randomly samples regularization parameter λ˜Uniform(0, 1) for each training batch. The stochastic regularization trains the VNN, h, 106 1 to flexibly handle operating tradeoffs across all values of the regularization parameter. To further improve the generalized meta learning approach, a conditional extension is employed that adds the regularization parameter 614 as an additional input to the VNN, h, i.e., σₛ=h(x, λ), to allow flexible control of the noise level and corresponding tradeoff at test time, without the need to retrain the VNN 106. Details of the generalized training of the VNN 106 are further described in conjunction with FIG. 6B, FIG. 7A, FIG. 7B, FIG. 7C, FIG. 7D and FIG. 7E.

Continuing further, the training procedure for the VNN, h, 106 for each data batch is includes randomly sampling the regularization parameter 614 as, λ˜Uniform(0,1). Further, a noise level 604 is determined based on the regularization parameter 614 and input sample(s) or input data, depicted as the input sample 602. The determined noise level 604 can be represented as: σₛ=h(x, λ) for each of the input sample, x in the input data batch. Thereafter, the transformation neural network 108, i.e., a soft smoothed classifier, given by the Eq. (5) is applied on the noise level 604 to produce a perturbed input sample. Based on perturbed input sample for each of the input samples of the input data batch, a robust transformation may be generated. Further, a regularized loss function, [symbol] , 612 is evaluated for each input sample using the Eq. (7). Subsequently, gradient of the VNN 106 is calculated with respect to the total batch loss and the VNN 106 is updated 616 to minimize the loss.

### Overview of Generalized Training for Variation Randomized Smoothing

FIG. 6B illustrates a schematic diagram 600B of generalized training of the VNN 106 for multi-stage variational randomized smoothing, in accordance with some example embodiments of the present disclosure. FIG. 6B is described in conjunction with FIG. 1, FIG. 3, FIG. 4A, FIG. 4B, FIG. 4C, FIG. 5A, FIG. 5B FIG. 5C and FIG. 6A.

In this regard, the VNN 106 is fed with three inputs. This is represented as h:x+ε, σₐ, and λ. The perturbed input x+ε is directly fed into a first convolutional layer of the VNN 106 from a previous epoch or batch of the VNN 106 or the transformation neural network 108. Both augmentation noise, σₐ, 618 and the regularization parameter, λ, 614 are used as supporting information for selecting the noise level, σₛ, 604 for the input sample, x, 602. Positional encoding and self-attention are used for the inputs of the augmentation noise, σₐ, 618 and the regularization parameter, λ, 614. The positional encoding layers for the augmentation noise, σₐ, 618 and the regularization parameter, λ, 614 may be added after a first convolution layer of the neural network 104 or the VNN 106 and followed by a self-attention layer.

In an example, the augmentation noise, σₐ, 618, may be fixed. In this regard, the augmentation noise, σₐ, 618 may be chosen from 0.12, 0.25, 0.50, and 1.00. In another example, the augmentation noise, σₐ, 618, may be generalized. In this regard, another model, ƒᵤ, may be trained with the fixed σₐ, by randomly sampling σₐ˜Uniform(0, 1) during training, i.e.,

$${σ}_{a}^{′} = 1.$$

Further, the VNN 104 may be trained for 200 epochs for the base model or the neural network 104 with the same corresponding data augmentation, and parameters

$${N}_{f}^{tr} = {N}_{h}^{tr} = 10.$$

For the VNN 106 trained for a base model of the neural network 104, θ, having fixed augmentation noise, σₐ, 618, the corresponding σₐ is used as the input to the VNN 106. For the case of VNN 106 trained for the neural network 104 having the generalized augmentation noise, σₐ, the augmentation noise, σₐ, 618 in the VNN 106 may be set to 0.5 and the target noise level, σₜ, 610 may be set as: σₜ=2σₐ.

Based on the inputs, i.e., input perturbations, x+ε, the augmentation noise, σₐ, 618 and the regularization parameter, λ, 614, the VNN 106 is trained to produce the sample-wise noise levels 604 for the input sample(s), x, 602. The sample-wise noise levels 604 may be generated using Gaussian noise 620, i.e., by sampling Gaussian noise. The Gaussian noise may be used to produce more than one noise level for a single input sample 602, or single noise level for each of the input samples in input data. The noise level 604 may be used to perturb the original input sample, x, or a previously perturbed input sample, x+ε. In this manner, various input samples may be perturbed. These perturbed input samples may be processed with the transformation neural network 108 to perform a transformation on the perturbed input sample(s), such as based on one or more downstream task. The transformations of the perturbed input samples produced by the transformation neural network 108 may be used to develop defense, and/or perform a task on the input sample. For example, once trained, a resilience or robustness of the transformation neural network 108 for producing a prediction or a classification output is improved, such as to identify an adversarial perturbation and/or prevent such adversarial perturbation from significantly modifying weights or gradients of the neural network 104.

FIG. 7A depicts a high-level schematic diagram 700A of the VNN 106 to produce the noise level 604 for the input sample 602, in accordance with some example embodiments of the present disclosure. FIG. 7A is explained in conjunction with FIG. 1, FIG. 3, FIG. 4A, FIG. 4B, FIG. 4C, FIG. 5A, FIG. 5B, FIG. 5C, FIG. 6A, and FIG. 6B.

As shown in FIG. 7A, the VNN 106 received three inputs, represented as h:x+ε, σₐ, and λ. Herein, E are a set of random noises 702, x+ε are input perturbations 704, σₐ is the augmentation noise 618 and λ is the regularization parameter 614. For example, the augmentation noise 618 and the regularization parameter 614 are used as supporting information or conditional information for selecting the noise level 604 for the input samples.

The VNN 106 includes linear transformation layer 710A and 710B (collectively referred to as linear transformation layers 710). The linear transformation layers 710 may perform a linear mapping of input data to output data using a matrix of weights and a bias vector. For example, the linear transformation layer 710A may map the regularization parameter 614 with an input sample that is perturbed based on the augmentation noise, σₐ, 618, such as a fixed augmentation noise 618. Similarly, the linear transformation layer 710B may map the augmentation noise 618, such as a generalized augmentation noise 618, with an input sample that is perturbed based on the fixed augmentation noise, σₐ, 618.

Further, a model architecture of the VNN 106 is shown to have three convolution layers (depicted as convolution layers 706A, 706B and 706C, and collectively referred to as convolution layers 706). The convolution layers 706 in the VNN 106 may perform the operations of convolution on the input data, such as the input sample 602 which can be an image or any multidimensional data. The convolution layers 706 may apply a set of filters (also called kernels) to the input data to produce a feature map. The convolution layers 706 may apply filter slides over the input sample 602, performing element-wise multiplications and summations, and may apply a ReLU activation function to introduce non-linearity. For example, the convolution layer 706A may produce a feature map for the perturbed input sample.

Further, the VNN 106 comprises self-attention layer 708 that allows the VNN 106 to weigh and consider different parts of the input sample 602 when making predictions, i.e., selecting a noise level 604. To this end, perturbed input sample is directly fed into the first convolutional layer 706A. The augmentation noise, σₐ, 618 and the regularization parameter 614 are used as conditional information for selecting the noise level 604. The linear transformation layers 710 map produce positional encodings of the mappings that are further analyzed with the self-attention layer 708 and processed further with the convolution layers 706B and 706C. Thereafter, the fully connected layer 712 or a dense layer may combine features of the perturbed input sample from the previous layers into a single global representation to make final predictions; and the exponential layer 714 applies an exponential function to each element of the input tensor. Thereafter, the noise level 604 for the input sample, x, 602, is predicted.

### Overview of Adversarial Training

The VNN 106 and the transformation neural network 108 are trained with adversarial training using adversarially perturbed data according to an adversarial attack such as Projected Gradient Descent (PGD) attack. In this regard, the neural network 104 may use the adversarially perturbed data or adversarial examples used by the adversarial model for training thereof. In this regard, the VNN 106 may learn the strength or level of noise to be added based on the adversarially perturbed data.

FIG. 7B illustrates a schematic illustration 700B of an inner training loop for performing an adversarial training, in accordance with some example embodiments. In an example, the adversarial training is performed for a neural network 716. The neural network 716 may be the VNN 106 or the transformation neural network 108. FIG. 7B is explained in conjunction with elements of FIG. 7C.

In an example, the adversarial training is conducted based on training loops. The training loops may include two iterative updates performed in an inner loop and an outer loop. The inner loop updates adversarially perturbed data 724. For an index, i, in a training batch, let δᵢ be the adversarial perturbation 722 for given input samples, xi, 726 with the corresponding corrected label, yᵢ, 728. The perturbed data 724 is denoted by xᵢ+δᵢ. Let [symbol] be a loss function. ƒ(xᵢ+δᵢ, θ) that denotes an output of the VNN 106 or the transformation neural network 108 given the perturbed data, xᵢ+δᵢ, 724 and the network parameters, θ, 720. An objective function of the inner loop is to find an optimized adversarial perturbation

$${δ}_{i}^{*}$$

while maximizing L as defined below:

$${δ}_{i}^{*} = {arg max}_{{δ}_{i}} ℒ ( f ( {x}_{i} + {δ}_{i} , θ ) , {y}_{i} ) \qquad ( 8 )$$

Further, an inner updater 718 implements an iterative algorithm to update the adversarial perturbation, δᵢ, 722.

In addition, the outer loop for the adversarial training updates the network parameters 720 associated with the neural network 716. Let B be an adversarial training batch size. An objective function of outer loop, which is regarded as the objective of the adversarial training, is represented by a minimization problem to find the network parameters 720 minimizing effects of the optimized adversarial perturbation

$${δ}_{i}^{*}$$

as follows.

$$F ( θ , {δ}_{i}^{*} ) = {θ}^{*} = {arg min}_{θ} \frac{1}{B} {\sum }_{i = 1}^{B} ℒ ( f ( {x}_{i} + {δ}_{i}^{*} , θ ) , {y}_{i} ) \qquad ( 9 )$$

Thus, adversarial training involves a bi-level optimization problem involving the objective functions for the inner training loop and outer training loop.

The update processes in the outer training loop and inner training loop involve iterative solvers, such as SGD and Adam which use gradient descents for the updates of the network parameters 720 and the adversarially perturbed data 724. Let θ^{k} and θ^{k+1} be network parameters at step k and k+1, respectively. Given learning rate α, θ^{k+1} is obtained by

$${θ}^{k + 1} = {θ}^{k} - α {∇}_{θ} F ( {θ}^{k} , {δ}_{i}^{*} ) \qquad ( 10 )$$

FIG. 7C illustrates a schematic illustration 700C of an outer training loop for performing an adversarial training, in accordance with some example embodiments. In an example, the adversarial training is performed for a neural network 716. The neural network 716 may be the VNN 106 or the transformation neural network 108. FIG. 7C is explained in conjunction with elements of FIG. 7B.

In this regard, an outer updater 730 uses the correct label 728, parameters, c, 752, and perturbed data 724 as input to update the network parameters 720. In an example, the outer updater 730 uses a computation graph 734 corresponding to the adversarial perturbation 722.

$$F ( {θ}^{k} , {δ}_{i}^{*} )$$

involves inner training loop update steps to obtain

$${δ}_{i}^{*} .$$

Various schemes to determine an outer gradient

$${∇}_{θ} F ( {θ}^{k} , {δ}_{i}^{*} )$$

can be defined in terms of how the inner training loop update steps are treated in the outer gradient determination. In an example, a method for the inner training loop update is one of the conventional schemes of adversarial training which simply uses

$${x}_{i} + {δ}_{i}^{*}$$

as input to ƒ to obtain the outer gradients. The inner training loop determines

$${δ}_{i}^{*}$$

given the input samples, xᵢ, 726, and then an outer training loop step updates the network parameters, θ, 720 using

$${x}_{i} + {δ}_{i}^{*}$$

as input to ƒ. This alternating update process is repeated until convergence.

Further, explicit differentiation may be used to update the network parameters, θ, 720 using an unrolled computation graph 734 determined by the inner training loop. This approach computes the outer gradients according to iterative numerical computations of the inner training loop. Hence, this approach keeps an entire computation graph 734 created for updating the adversarial perturbation 722 δᵢ in the inner training loop. The update steps of the outer training loop use the unrolled computation graph 734 for a backpropagation to obtain the outer gradients to update the network parameters, θ, 720 and to obtain updated network parameters 732.

Further, implicit differentiation can be used to obtain the outer gradients. As the adversarial perturbation, δᵢ, 722 can be viewed as an implicit function of the network parameters, θ, 720, the outer gradients can be determined based on an implicit function theorem. This approach does not require any backpropagation through an entire unrolled computation graph 734 as used in the explicit differentiation approach.

FIG. 7D illustrates a high-level schematic illustration 700D of the inner updater 718 for adversarial training of the neural network 716, in accordance with some example embodiments. In an example, the adversarial training is performed for the neural network 716. The neural network 716 may be the VNN 106 or the transformation neural network 108. FIG. 7D is explained in conjunction with elements of FIG. 7B and FIG. 7C.

In an example, implicit differentiation may be used for the adversarial training based on the Carlini & Wagner (CW) attack. The CW attack is an approach to generate adversarial examples. The CW attack defines a variable wᵢ, which satisfies the adversarial perturbation, δᵢ, 722 as:

$${δ}_{i} = \frac{1}{2} ( tan ( {w}_{i} ) + 1 ) - {x}_{i} .$$

Let Z(·)ₜ denote logits 736 of the neural network 716 parameterized by the network parameters, θ, 720 corresponding to a correct class, t. An objective function 738 of the CW attack is defined as follows.

$$G ( {w}_{i} , θ ) = {‖ \frac{1}{2} ( tan ( {w}_{i} ) + 1 ) - {x}_{i} ‖}_{2}^{2} + c \cdot f ( \frac{1}{2} ( tan ( {w}_{i} ) + 1 ) ) , \qquad ( 11 )$$

where

$$f = max [ {max}_{i \neq t} {Z ( \frac{1}{2} ( tan ( {w}_{i} ) + 1 ) )}_{i} - {Z ( \frac{1}{2} ( tan ( {w}_{i} ) + 1 ) )}_{t} ) , 0 ] .$$

The goal of the CW attack is to find

$${w}_{i}^{*} = {arg min}_{{w}_{i}} G ( {w}_{i} , θ ) .$$

For example, a best adversarial example against xᵢ is obtained by casting back

$${w}_{i}^{*} to {δ}_{i}^{*} ; therefore , {δ}_{i}^{*} = \frac{1}{2} ( tan ( {w}_{i}^{*} ) + 1 ) - {x}_{i} .$$

In particular, to obtain inner gradients regarding the CW attack based on implicit differentiation,

$${w}_{i}^{*}$$

must be obtained first.

According to FIG. 7D, the inner updater 718 is used for implicit differentiation. Subsequently, the inner updater 718 uses gradient descent 740 to update the variable w^{k}, 742. For example, an encoder 744 may encode the input samples, xᵢ, 726 to determine initial variable, w°, 746. The initial variable, w°, 746 may get iteratively updated based on the determined gradients to produce the variable, w^{k}, 742. Further, a decoder 748 may use the variable, w^{k}, 742 to generate the perturbed data, xᵢ+δᵢ, 724 and update the network parameters, θ, 720. After sufficient number of or steps of updating of the variable, w^{k}, 742 based on the determined gradients 740, the variable, w*, 750 is obtained for performing adversarial training of the neural network 716 based on the implicit differentiation.

FIG. 7E illustrates a high-level schematic illustration 700E of an implicit differentiation module 754 for performing adversarial training of the neural network 716 using implicit differentiation, in accordance with some example embodiments. In an example, the adversarial training is performed for the neural network 716. The neural network 716 may be the VNN 106 or the transformation neural network 108. FIG. 7E is explained in conjunction with elements of FIG. 7A, FIG. 7B, FIG. 7C and FIG. 7D.

According to FIG. 7E, the implicit differentiation module 754 obtains the inner gradient based on the variable, w*, 750 obtained or produced by the inner updater 718. A gradient calculator 756 derives inner gradients 758 from the variable, w*, 750 and the objective function 738 based on the implicit function theorem. These inner gradients 758 may be used in the outer training loop to update the network parameters, θ, 720 of the neural network 716.

### Overview of Operation of the Neural Network

FIG. 8 illustrates a block diagram 800 of implementation of the neural network 104 for a downstream task, in accordance with some example embodiments of the present disclosure. FIG. 8 is described in conjunction with elements from the FIG. 1, FIG. 3, FIG. 4A, FIG. 4B, FIG. 4C, FIG. 5A, FIG. 5B, FIG. 5C, FIG. 6A, FIG. 6B and FIG. 7.

After the training of the neural network 104 for adversarial robustness, the neural network 104 may be deployed to perform various downstream tasks while maintaining resilience against adversarial attacks. Examples of the downstream tasks may include, but are not limited to, image classification into predefined categories, object detection, semantic segmentation, natural language processing tasks, speech recognition, malware detection, fraud detection, autonomous navigation, biometric authentication, and personalized recommendation prediction.

In this regard, the transformation neural network 108 may be a classifier or a prediction model that may be trained and/or fine-tuned on target data to perform a downstream task 802. For example, the robust transformation 110 of the input data 102 may be used by the transformation neural network 108 to assign a classification label to the input data such that the perturbation or noise in the robust transformation is taken into account while predicting and assigning the classification label.

In operation, the robust transformation 110 of the input data 102 may be processed data by a downstream application to perform the downstream task 802. In an example, the downstream application may relate to malware detection, and the downstream task 802 may relate to identifying malicious email and/or software. To this end, the downstream task 802 may be performed by the downstream application using the neural network 104 or the trained transformation neural network 108. Subsequently, during the task, a state of the task 804 may be sent as a feedback signal from the downstream application to the neural network 104. The state of the task 804 may indicate, for example, predictions made by the transformation neural network 108, inaccuracies in outputs generated by the transformation neural network 108, robustness of the transformation neural network 108, etc. with respect to the downstream task 802 The state of the task 804 may be used to adjust a value of the noise strength scaler 304 defining the regularization parameter of the VNN 106. This may be done to modify a noise of level or strength of noise used for training the VNN 106 and the transformation neural network 108. Subsequently, the neural network 104 may update its performance by changing noise levels for input data received during the downstream task 802.

In certain cases, the VNN 106 and the transformation neural network 108 are fine-tuned at a target condition. In other words, the VNN 106 and the transformation neural network 108 may be pre-trained on general domain of data. Further, once deployed on the downstream application, the VNN 106 and the transformation neural network 108 may get fine-tuned on a specific dataset or under specific target condition that closely matches the intended use case or the downstream task to be performed by the transformation neural network 108. In an example, the target condition may be set by updating the regularization parameter 614 and/or a stochastic regularization of the regularization parameter 614.

In certain cases, the VNN 106 and the transformation neural network 108 may operate complementary to the adversarial model, such as during an inference phase of the downstream application. In this regard, the VNN 106 and the transformation neural network 108 may get fine-tuned during the inference phase based on training data or the adversarially perturbed data used by the adversarial model for training.

In an example, the transformation neural network 108 is a deep neural network. The transformation neural network 108 may be trained with augmented data with a set of augmentation parameters for one or a combination of automatic speech recognition, language modeling, log data modeling, and variants thereof. The set of augmentation parameters may define settings or variables that define how data augmentation is applied. Augmentation is applied to add adversarial examples or noises into input samples to create additional training data. For example, in the context of speech recognition, spoken language may be converted into text. Subsequently, augmentation parameters may include, but are not limited to, background noise, changing a speed or a pitch of the audio, and adding reverberation to simulate different acoustic environments. In language modelling, augmentation parameters may include, for example, synonyms substitution, random deletion, or insertion of words, or paraphrasing to create varied textual data.

Further, the VNN 106 and the transformation neural network 108 accept the set of augmentation parameters as a conditional information. To this end, the augmentation parameters are provided as the conditional information in form of the augmentation noise 618, a.

In an example, the transformation neural network 108 or a base classifier, ƒ, is trained with two types of Gaussian augmentation. A first training may involve training with a fixed Gaussian augmentation, i.e., fixed value of the augmentation noise 618, σₐ; while a second training may involve training with a generalized Gaussian augmentation, i.e., universal, or generalized value of the augmentation noise 618, σₐ. The first training may be performed based on conventional approach to train the transformation neural network 108 with a same noise level, indicated by the augmentation noise 618, σₐ, for each of multiple input samples, such as all input images in the input data 102. An input sample is denoted as x. To this end, training with a fixed σₐ is expected to work with σₛ close to σₐ as shown.

However, choosing a proper σₐ at a training time is a complex process to ensure high effectiveness of the training. To address this, the second training or generalized σₐ. Training is employed. In this regard, random samples for σₐ˜Uniform (0, σ′ₐ) are generated or produced for each input sample 602, x, in every training batch. Further, the generalized augmentation noise, σₐ, training adapts the transformation neural network 108 to be suitable for a wide range of augmentation parameters and/or augmentation noise, σₐ. This offers more flexibility than fixed training or the first training, which would require multiple, separate classifiers for different operating points. For example, due to the conditional meta learning by inputting the augmentation noise, σₐ, to the generally trained transformation neural network 108 allows adjustment of its point during test time.

Further, since the VNN 106 is a neural network and prone to adversarial attacks, therefore a defense is also applied to the VNN 106. In an example, the VNN 106 may be operable to select continuous noise levels for input samples. For example, the continuous noise levels may include values that may take on any number within a given range. These values may be drawn from continuous distributions such as the Gaussian (normal) distribution, uniform distribution, exponential distribution, or other continuous probability distributions. Due to the use of continuous noise levels in defining the noise level 604, median smoothing is performed.

Median smoothing uses a median of multiple regressor outputs for a Gaussian augmented input as a smoothed prediction result. For example, a smoothed classifier, i.e., the transformation neural network 108, that uses the VNN 106 with median smoothing, is denoted as

$${g}_{{v}_{a}}^{*} .$$

In an example, the transformation neural network 108 is configured to perturb an input, such as the input sample, x, 602 with Gaussian noise

$$ε ∼ N ( 0 , {σ}_{m}^{2} {I}_{d} ) where {σ}_{m} > 0$$

is a median smoothing noise level.

In an example, hp(x+ε) may denote pth percentile of an output of h(x+ε) with respect to the statistics of a Gaussian input perturbation. For example, median smoothing may use a median, defined as σₛ=h_{50%}(x+ε), as smoothed result of the VNN, h, 106. For example, during the training of the VNN 106, as described in conjunction with the FIG. 5A, FIG. 5B, FIG. 5C, FIG. 6A and FIG. 6B, as well as during testing phase or test time, the median may be empirically computed from multiple samples. Subsequently, the smoothed output of the VNN 106, i.e., the median smoothed noise level 604, σₛ, is used for successive randomized smoothing of the transformation neural network 108 for producing the robust transformation. Thus, the dual smoothing is employed to protect the transformation neural network 108 as well as the VNN 106.

In an example, the median smoothing provides guarantees in the form of upper bound and lower bound on an output, i.e., the noise level 604, of the VNN 106 in the presence of any adversarial perturbation δ∈ [symbol] ^{d}, within a given radius ∥δ∥₂<D. Further, h, may be used to denote the lower bound while, h̅, may be used to denote the upper bound of an of the VNN 106, h. Moreover, shorthand is defined by: x′:=x+δ. For any perturbation δ ∈ [symbol] ^{d}, with ∥δ∥₂<D, the median smoothing may provide the upper bound and the lower bound on the median smoothed output, given by

$${\underline{h}}_{\underline{p}} ( x + ε ) \leq {h}_{p} ( {x}^{′} + ε ) \leq {\overline{h}}_{\overline{p}} ( x + ε ) \qquad ( 8 )$$

$$where \underline{p} = Φ ( {Φ}^{- 1} ( p ) - \frac{D}{{σ}_{m}} ) and \overline{p} = Φ ( {Φ}^{- 1} ( p ) + \frac{D}{{σ}_{m}} ) .$$

For the case of median (p=50%), the lower bound may be obtained as

$$\underline{p} = Φ ( - \frac{D}{{σ}_{m}} )$$

and the upper bound may be obtained as

$$\overline{p} = ( + \frac{D}{{σ}_{m}} ) .$$

For example, it is intractable to determine exact distributions and percentiles for the lower bound and the upper bound. Hence, a Monte-Carlo method may be used to approximate the values of the lower bound, hₚ, and the upper bound, h̅ₚ. In this regard, Nₕ samples of h(x+εₖ), for k ∈ {1, 2, . . . , Nₕ} are generated. Then, the samples are sorted based on their magnitude in an ascending order. For example, h_{q} may denote the values of the samples with a sorted index q. Thereafter, indices qᵢ and qᵤ that correspond to the lower bound p and the upper bound p̅ within a confidence level αₕ are determined. Using qₗ and qᵤ, empirical upper bound and lower bound of h(x′+ε) are determined as h_{ql}(x+ε) and h_{qu} (X+ε), respectively. For example, the number of samples, Nₕ, may be increased to minimize a gap between theoretical upper and lower bounds and the empirical upper and lower bounds.

In an example, a certified robustness of the neural network 104 may be discussed using the upper and the lower bounds on the output, i.e., noise level 604, of the VNN 106 determined by median smoothing. In an example, a set of indices, [symbol] , is assumed to be satisfying [symbol] ={q ∈Z |qₗ≤q≤qᵤ}. To this end, a number of possible noise levels 604 that may be generated by the VNN 104, σₛ=h_{q}(x+ε), is | [symbol] |, and the certified accuracy and radius for x is analyzed across all possible σₛ.

### Overview of Exemplary Operations

FIG. 9 illustrates a block diagram 900 of implementation of the neural network 104 for outputting a robust transformation 910 of discreet input data 902, in accordance with some example embodiments of the present disclosure. FIG. 9 is described in conjunction with elements from the FIG. 1, FIG. 3, FIG. 4A, FIG. 4B, FIG. 4C, FIG. 5A, FIG. 5B, FIG. 5C, FIG. 6A, FIG. 6B FIG. 7 and FIG. 8.

According to the present disclosure, the neural network 104 utilizes an encoder 904 as well as the VNN 104 and the transformation neural network 108 to generate the robust transformation 910 of the discrete input data 902. In this regard, the encoder 904 is configured to generate embeddings of the discrete input data 902 as continuous embedding vectors 906 in a continuous space.

In an example, the discrete input data 902 may be received from categorical variables. For example, datasets including categorical variables may include discrete variables that represent categories or groups. These variables may include attributes such as gender, ethnicity, product type, customer segment, etc. In another example, the discrete input data 902 may be received from text data sources.

In an example, the encoder 904 is configured to embed the discrete input data 902 into the continuous space to produce the continuous embedding vectors 906. Typically, embedding is a method of mapping high-dimensional data, such as the discrete input data 902 to a low-dimensional space, such as the continuous space. This may be used to transform non-continuous discrete input data 902 into continuous vector representations for further processing.

In an example, the encoder 904 may include an embedding layer. In an example, the encoder 904 may be configured to represent each discrete value of the discrete input data 902 as a binary vector where all elements are zero except for the one corresponding to the value's index. For example, for a categorical variable with three possible values, each of the values may be encoded as a vector of length three. Once encoded, each of the vectors of the discrete input data 902 may be passed through the embedding layer of the encoder 904. The embedding layer may map each of the encoded vector to a continuous vector representation to produce the continuous embedding vectors 906. For example, the embedding layer may be a lookup table, where each row corresponds to a unique discrete value, and the encoder 904 learns to update the values in the lookup table during training to optimize the embedding task.

Thereafter, the continuous embedding vectors 906 are fed to the VNN 106. The VNN 106 may process the continuous embedding vectors 906 to produce or select a noise level 908 for, for example, each of the continuous embedding vectors 906. A manner in which the VNN 106 is trained and operates to produce the sample-wise noise levels 908 is described in conjunction with, for example, FIG. 1, FIG. 3, FIG. 5A, FIG. 5B, FIG. 5C, FIG. 6A, FIG. 6B, FIG. 6C, FIG. 7, and FIG. 8.

Further, a probabilistic distribution, such as a Gaussian distribution having a variance defined by the sample-wise noise level 908 is sampled to determine a set of random noises 912. These set of random noises 912 are sampled or taken from the probabilistic distribution dependent on the input data, i.e., the continuous embedding vectors 906 of the discrete input data 902. The set of random noises 912 are injected or added to the input data, i.e., the continuous embedding vectors 906 to produce a set of perturbed input samples 914. The set of perturbed input samples 914 may include input samples perturbed with a random noise level, such that each of the continuous embedding vectors 906 may be perturbed with a random value from the set of random noises 912 which has dependency on input data.

In one example, the set of random noises 912 may be gaussian noise sampled from a normal distribution based on the determined noise level 908. Further, a magnitude of the gaussian noise may be controlled or adjusted to the predetermined magnitude by adjusting a standard deviation of the normal distribution based on the noise level 908. Such gaussian noise introduces random perturbations to the continuous embedding vectors 906. In another example, the set of random noises 912 may be adversarial noise that may be carefully crafted to maximize a loss function of the neural network 104 while remaining imperceptible. In yet another example, the set of random noises 912 may be random perturbations that may be added to the continuous embedding vectors 906 by adding small, random offsets to each dimension of the continuous embedding vectors 906.

In certain other cases, the set of random noises 912 may be added or injected to the continuous embedding vectors 906 using dropout regularization, data augmentation, or gradient masking. For example, the dropout regularization may cause to randomly set a fraction of elements in the continuous embedding vectors 906 to zero, effectively introducing noise. Moreover, the data augmentation may introduce random transformations to the continuous embedding vectors 906 by, for example, rotations, translations, or scaling. In addition, the gradient masking intentionally masks or manipulates gradients of continuous embedding vectors 906.

The injection of the set of random noises 912 may modify the embedding vectors 906 in a way that makes the embedding vectors 906 slightly different from their original representations. This allows the perturbed embeddings to defend against an adversarial input attack by essentially drowning those small adversarial perturbations with random noise.

Further, the set of perturbed input samples 914 is provided to the transformation neural network 108. The transformation neural network 108 may process each of the set of perturbed input samples 914 to produce a set of transformations 916. The transformation neural network 108 is a deep neural network trained for one or a combination of: automatic speech recognition, language modelling, and log data modelling. For example, the transformation neural network 108 may be a transformer-based model having the ability to capture long-range dependencies and contextual information effectively. The transformation neural network 108 may be used for performing several tasks, such as modifying input, i.e., the set of perturbed input samples 914, to draw conclusions and/or generate outputs. Examples of the tasks that may be performed by the transformation neural network 108 may include, but are not limited to, language modeling, machine translation, speech recognition, text generation, question answering, text classification, named entity recognition, and summarization.

To this end, the set of perturbed input samples 914 may be transformed into the set of transformations 916 based on a transformation task associated with the transformation neural network 108. The transformation task may indicate a function or a type of transformation to be performed on the set of perturbed input samples 914 in order to carry out a task associated with the transformation neural network 108 or the neural network 104.

Further, a combination of the set of transformations 916 is output as the robust transformation 910 of the discrete input data 902. In an example, the combination of the set of transformations 916 is an aggregation of the set of transformations 916. In another example, randomly selected transformations from the set of transformations 916 may be aggregated to generate the output. The output may be the robust transformation 910 that may form the defense of the neural network 104 and enable the neural network 104 to provide robust output, i.e., perform tasks accurately even with slight perturbations.

### Overview of Exemplary Implementation

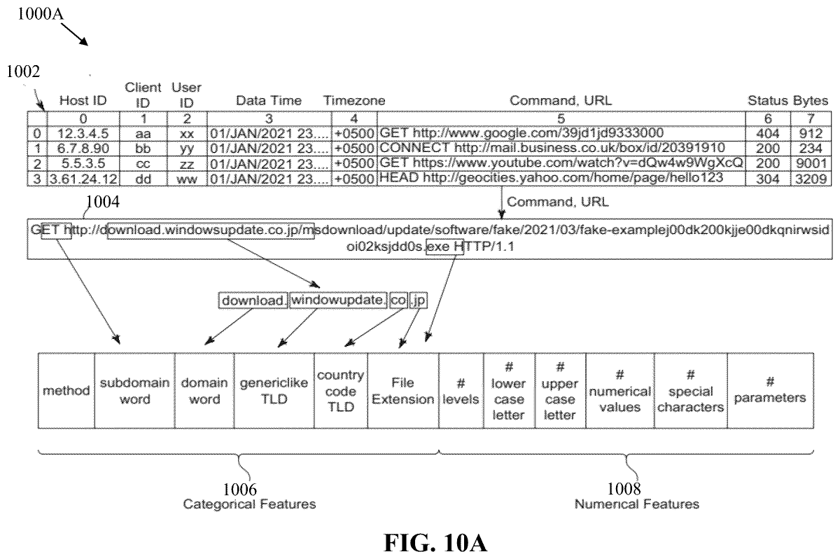

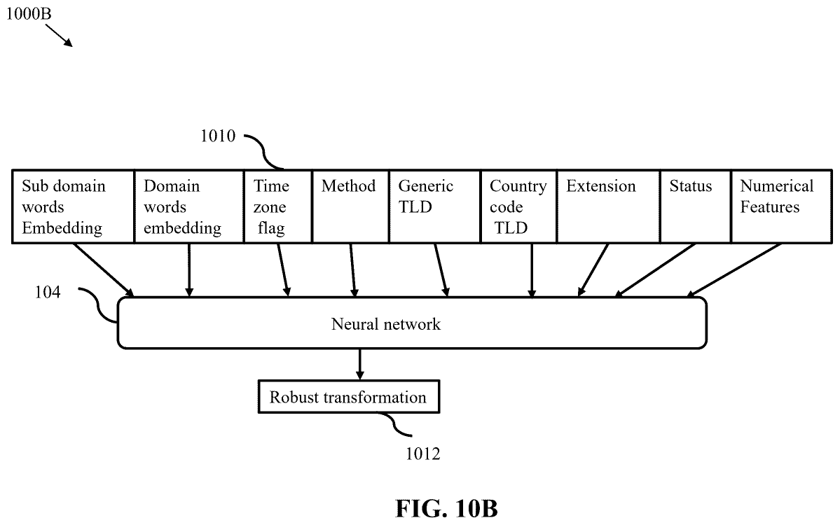

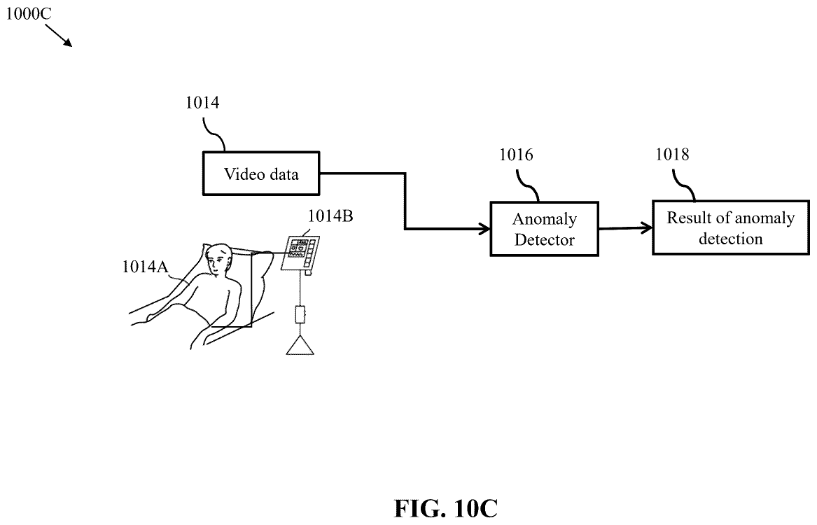

FIG. 10A and FIG. 10B illustrate exemplary input data 102 as internet proxy log data, in accordance with some example embodiments of the present disclosure.

Referring to FIG. 10A, a schematic illustration 1000A for exemplary input data as internet proxy log data is shown. The internet proxy log data 1002 is decomposed into categorical features and numerical features. The internet proxy log data 1002 comprises information associated with requests made by a user to a network. For example, the internet proxy log data 1002 comprises host id, client id, and user id of the user that has requested the network to access a specific website or web content. The internet proxy log data 1002 further comprises data time, time-zone, and command used by the user to access the specific website or the web content along with information about status of the command and number of bytes used by the command.

The internet proxy log data 1002 is raw data that comprises sequences of log entries of internet traffic requests from many different users, where these sequences of log entries are inherently interleaved in the internet proxy log data 1002. Thus, in order to detect anomaly in the internet proxy log data 1002, an anomaly detector neural network, such as the neural network 104 may have to first de-interleave the sequences of log entries generated by different users, and then handle each user's sequence independently. Further, simply processing all of the sequences while interleaved may overburden the neural network with additional unnecessary complexity.

A Uniform Resource Locator (URL) 1004 corresponding to one of the de-interleaved sequences may be obtained by the anomaly detector, where the anomaly detector decomposes the URL 1004 into a plurality of parts based on the plurality of features comprised in the URL 1004. The URL 1004 comprises different information associated with the request made by the user to access the website or the web content. The information comprised by the URL 1004 is decomposed into categorical features 1006 and numerical features 1008. The information decomposed into the categorical features 1006 comprises method name used by the user to access the website, in this case method name corresponds to “GET”, where GET is a default HTTP method that is used to retrieve resources from a particular URL. The information comprised in the categorical features 1008 further includes sub-domain words, in this case “download”; domain words, in this case “windowsupdate.”; generic-like top-level domain (TLD): “co.”; country code TLD: “.jp”; and file extension: “.exe”. The subdomain word and domain word may be further categorized into embedded features due to the very large word vocabulary sizes.

Further, information of the URL 1004 categorized into numerical features 1008 comprises number (#) of levels, # of lowercase letters, # of uppercase letters, # of numerical values, # of special characters, and # of parameters. The data corresponding to each feature is vectorized. The vectorized data corresponding to the categorical features 1006 and the numerical features 1008 is provided to the neural network 104 for anomaly detection.

FIG. 10B illustrates a block diagram 1000B of the neural network 104 for performing robust transformation 1012 for categorical input 1010 comprising the categorical features 1006 and the numerical features 1008, according to some embodiments of the present disclosure.

In order to vectorize data (text) in the domain and sub-domain words, an encoder may be used. For example, the encoder may be used for embedding the input data, i.e., the categorical input 1010, into a continuous space. Subsequently, the operations of the VNN 106 and/or the transformation neural network 108 may be applied to the encoding of the categorical input 1010.

The categorical input 1010 or an embedding of the categorical input 1010 in a continuous space is provided to the neural network 104. The neural network 104 uses the VNN 106 to encode the categorical input 1010 into a latent space representation. Further, the categorical input 1010 may be processed with a smoothed classifier 206 to produce the prediction result 208 of anomaly detection, as explained above in FIG. 2A and FIG. 2B.

However, smoothed classifier 206 may fail to effectively balance a trade-off between robustness and accuracy while handling the large size of the categorical input 1010 for robust anomaly detection and accurate output or predictions. Moreover, an amount of noise or a strength of noise that can be added to input samples is low, thereby limiting training of the neural networks to only small perturbations.

In order to effectively train the neural network 104 to add sample-specific noise to input samples, variational randomized smoothing framework is used. The VNN 106 is used to select noise levels suitable for each input sample of the categorical input 1010. variational randomized smoothing framework to select noise levels suitable for each input sample by using a noise level selector. The variational framework is used to build the VNN 106 composed of a neural network to determine sample-wise noise levels, q, for randomized smoothing. Further, a generalized training scheme is used for stochastic regularization 504, which makes the VNN 106 learn various conditions to produce different noise strengths at once by randomly sampling the regularization parameter 614. Further, controllability in the generalized training is improved by using conditional meta learning, which enables a user to freely adjust a noise strength by specifying the regularization parameter 614 for the noise strength scaler 302 at test time without a need for re-training.

Further, as the VNN 106 itself is a neural network, at some point, it may become a target of an adversarial attack. Therefore, a multi-stage smoothing based defensive method is employed to protect the VNN 106 as well as the transformation neural network 108. The multi-stage smoothing includes a first smoothing performed to determine the noise level 302 from random perturbation of the input data 102 on a probabilistic distribution with a fixed variance. Further, a second smoothing is performed to determine the robust transformation 1012 of the input data or the categorical input 1010 from random perturbation of the input data on a probabilistic distribution having a varying variance defined by the noise level. In this regard, a modified certified robustness for sample-wise smoothing is provided based on the bound of median smoothing.

In an example, the categorical input 1010 or an embedding of the categorical input 1010 in a continuous space is provided to the neural network 104. The neural network 104 may use an encoder to encode the categorical input 1010 into a latent space representation. Further, the encoded categorical input may be processed by the VNN to produce the noise level and inject random noises sampled on the noise level into the embeddings of the categorical input 1010. The transformation neural network 108 may further produce the robust transformation 1012 based on a combination of a set of transformations of perturbed input samples.

FIG. 10C illustrates a block diagram 1000C for anomaly detection in video data 1014, in accordance with an example embodiment. The video data 1014, a form of sequential data, may be real-time video and/or recorded video. In the FIG. 10C, the video data 1014 is of a patient 1014A lying in a bed, where heartbeat of the patient 1014A is being monitored using an electrocardiogram (ECG) machine 1014B. The video data 1014 is provided to an anomaly detector 1016. The anomaly detector 1016 may include the neural network 104 comprising the VNN 106 and the transformation neural network 108. On receiving the video data 1014, the anomaly detector 1016 may process the video data 1014. Each image frame of the video data 1014 comprises different features, for example, different color channels like green, red, blue, or the likes. The different features of the video data 1014 may comprise preprocessed motion vectors in addition to raw images. Further, each image frame is processed by the anomaly detector 1016 using a variety of tools, like object detection, skeleton tracking, and the likes that yields a plurality of features in the video data 1014 in addition to the raw pixel values.

For example, by using object detection tools, the anomaly detector 1016 can detect the ECG machine 1014B in image frames and zoom in or zoom out on the ECG machine 1014B in the image frames. Further, an image of an ECG graph on the ECG machine 1014B may be analyzed to detect anomaly in heartbeat of the patient 1014A. The anomaly detector 1016 may determine a sequence of losses corresponding to the images of the ECG graph on the ECG machine 1014B comprised in one or more image frames of the video data 1014. The anomaly detector 1016 uses the sequence of losses to determine a result of anomaly detection 1018 including a type of anomaly and/or a severity of anomaly in the heartbeat of the patient 1014A.

In another embodiment, the anomaly detector 1016 may be used to detect anomaly in a pose (or posture) of the patient 1014A. For example, the patient 1014A may be in an abnormal pose when the patient 1014A is about to fall from the bed. Further, the abnormal pose of the patient 1014A may be due to seizure attack. Based on the video data 1014, the anomaly detector 1016 may determine a plurality of features associated with movement of the patient 1014A from various image frames of the video data 1014. Further, skeleton tracking tools may be used by the anomaly detector 1016 to detect anomaly in position (or pose or posture) of the patient 1014A. Also, the anomaly detector 1016 may then determine a type of anomaly in the position of the patient 1014A.

### Overview of Exemplary Method

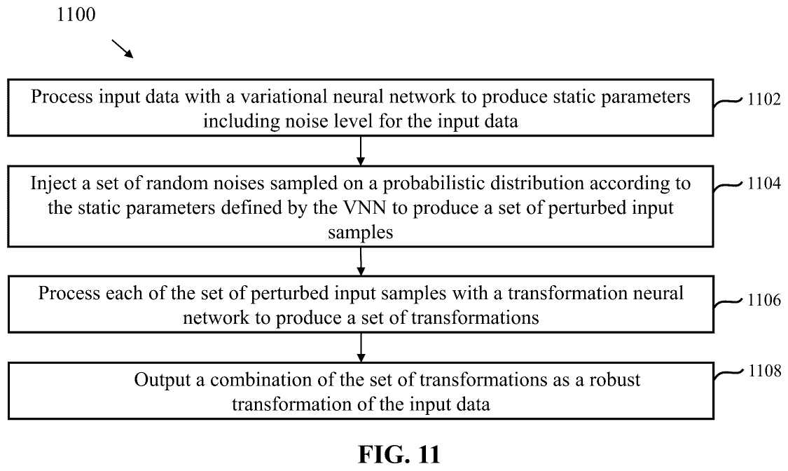

FIG. 11 illustrates a flowchart of a computer-implemented AI method 1100 for generating the robust transformation 110 of the input data 102, in accordance with some example embodiments of the present disclosure. FIG. 11 is explained in conjunction with FIG. 1, FIG. 3, FIG. 4A, FIG. 4B, FIG. 4C, FIG. 5A, FIG. 5B, FIG. 5C, FIG. 6A, FIG. 6B, FIG. 7, FIG. 8, FIG. 9, and FIG. 10.

At 1102, the input data 102 is processed by the VNN 106. The VNN 106 is trained with machine learning to produce statistic parameters including the noise level 302 for the input data 102. In an example, a processor associated with the neural network 104 is configured to utilize the VNN 106 to produce the sample-wise noise level 302 for the input data 102. In an example, the sample-wise noise level 302 is suitable for randomized smoothing of each input sample. In an example, the VNN 106 is trained with different values of the noise strength scaler 304 used as the regularization parameter 502 to adjust a strength of the noise level 304. In certain cases, the VNN 106 may be trained with the stochastic regularization 504 to produce the noise level 304 of different strengths for each input sample of the input data 102.

At 1104, a set of random noises sampled on a probabilistic distribution is injected to the input data 102. The probabilistic distribution may be according to the statistic parameters, such as a variance of the noise level, defined by the variational neural network. In an example, the processor associated with the neural network 104 is configured to inject the set of random noises to the input data 102 to produce a set of perturbed input samples. In an example, the set of random noises may be a set of Gaussian noise tensors. For example, a Gaussian noise tensor from the set of Gaussian noise tensors may have a shape or dimension of floating-point values. These Gaussian noise tensors may include independent Gaussian samples having a mean of zero and a standard deviation defined by the noise level. For example, the Gaussian noise tensors may be added to a corresponding tensor of floating-point values an input sample or features of the input data 102. In an example, the VNN 106 or the neural network 104 is configured to add the set of Gaussian noise tensors to the tensors of the input samples of the input data in parallel.

At 1106, each of the set of perturbed input samples is processed with the transformation neural network 108 to produce a set of transformations. In an example, the processor associated with the neural network 104 is configured to utilize the transformation neural network 108, specifically, hidden layers of the transformation neural network 108, to transform the set of perturbed input samples to the set of transformations based on a task for which the transformation neural network 108 is trained.

At 1108, a combination of the set of transformations is output as the robust transformation 110 of the input data 102. Further, the processor associated with the neural network 104 is configured to output the combination of the set of transformations as an aggregation or, an average of the set of transformations. In another example, the processor associated with the neural network 104 is configured to output the combination of the set of transformations as an average of probability vectors of the set of transformations, or a majority voting of hard decision of the probability vectors of the set of transformations. In this manner, the robust transformation 110 is generated from the input data 102 which enables the neural network 104 to form defense against adversarial attacks.

### Exemplar Implementation

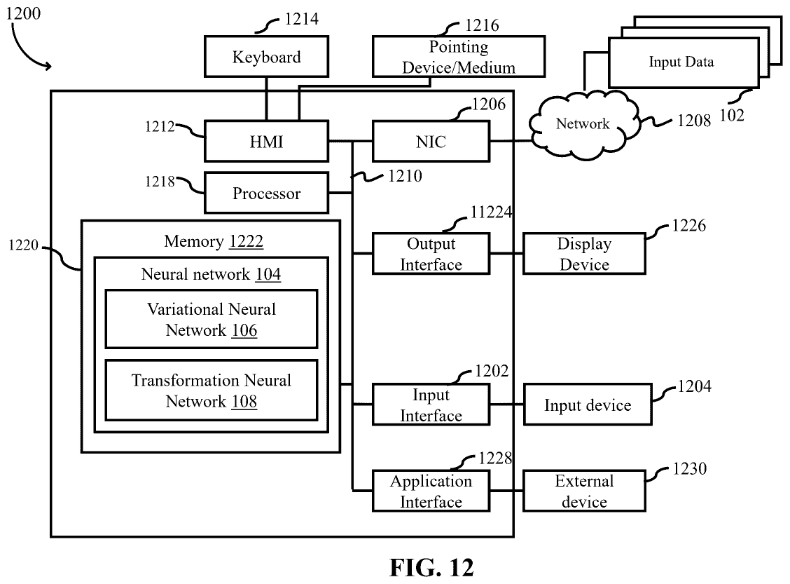

FIG. 12 illustrates a block diagram of a computer-based AI system 1200 for generating transformation of the input data 102, in accordance with an example embodiment. The computer-based AI system 1200 includes a number of interfaces connecting the system 1200 with other systems and devices. The AI system 1200 includes an input interface 1202 configured to accept the input data 102, where the input data 102 comprises data such as internet proxy data, text data, video data, audio data, image data, or the likes.

In some embodiments, the AI system 102 includes a network interface controller (NIC) 1206 configured to obtain the discrete input 102, via a network 1208, which can be one or combination of wired and wireless network.

The network interface controller (NIC) 1206 is adapted to connect the AI system 1200 through a bus 1210 to the network 1208 connecting the AI system 1200 with an input device 1204. The input device 1204 may correspond to a camera, a computing device, a sensor, a recorder that records proxy log data, etc. for recoding the input data 102 to be provided to the AI system 1200 to generate or output robust transformations corresponding to the input data 102.

Additionally, or alternatively, the AI system 1200 may include a human machine interface (HMI) 1212. The human machine interface 1212 within the AI system 1200 connects the AI system 1200 to a keyboard 1214 and a pointing device 1216, where the pointing device 1216 may include a mouse, trackball, touchpad, joystick, pointing stick, stylus, or touchscreen, among others.

The AI system 1200 includes a processor 1218 configured to execute stored instructions 1220, as well as a memory 1222 that stores instructions that are executable by the processor 1218. The processor 1218 can be a single core processor, a multi-core processor, a computing cluster, or any number of other configurations. The memory 1222 can include random access memory (RAM), read only memory (ROM), flash memory, or any other suitable memory systems. The processor 1218 may be connected through the bus 1210 to one or more input and output devices.

The instructions 1220 may implement a method for generating transformation of the input data 102, according to some embodiments. To that end, computer memory 1222 stores the neural network 104 comprising the VNN 106 and the transformation neural network 108.

The VNN 106 may generate noise levels for the input data 102. The noise levels may be dependent on input samples in the input data 102. The VNN 106 may further inject the sample-specific noise levels into the input data to produce a set of perturbed input samples. These perturbed input samples are then processed by the transformation neural network 108 to produce a set of transformations 402 of the input data 102 which may be associated with a task. The set of transformations 402 may be combined to generate an output. Such output corresponds to the robust transformation 110 of the input data 102.

In some embodiments, an output interface 1224 may be configured to render the output, i.e., the combination of the set of transformations 402, on a display device 1226. Examples of a display device 1226 include a computer monitor, television, projector, or mobile device, among others. The computer-based AI system 1200 can also be connected to an application interface 1228 adapted to connect the computer-based AI system 1200 to an external device 1230 for performing various tasks.

### Embodiments

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them.

Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship with each other.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

What is claimed is:

1. A computer-implemented artificial intelligence (AI) method for robust transformation of input data with a neural network, comprising:
processing the input data with a variational neural network trained with machine learning to produce statistic parameters including noise level for the input data;
injecting a set of random noises sampled on a probabilistic distribution according to the statistic parameters defined by the variational neural network to produce a set of perturbed input samples;
processing each of the set of perturbed input samples with a transformation neural network to produce a set of transformations; and
outputting a combination of the set of transformations as the robust transformation of the input data.

2. The AI method of claim 1, wherein the transformation neural network is a classifier such that the robust transformation of the input data includes a classification of the input data.

3. The AI method of claim 1, wherein the variational neural network accepts a noise strength scaler as a parameter to adjust a strength of the noise level based on the noise strength scaler.

4. The AI method of claim 3, wherein the variational neural network is a single model trained for different values of the noise strength scaler used as a regularization parameter.

5. The AI method of claim 4, wherein the variational neural network is trained with a stochastic regularization to produce the noise level of different strengths by randomly sampling the regularization parameter according to a random distribution.

6. The AI method of claim 5, wherein the variational neural network is trained with a weighted, scaled, and biased loss function according to the value of the randomly sampled regularization parameter.

7. The AI method of claim 3, further comprising:
accepting a value of the noise strength scaler from a user interface.

8. The AI method of claim 3, further comprising:
processing the robust transformation of the input data by a downstream application to perform a task;
receiving a state of the task as a feedback signal from the downstream application; and
adjusting a value of the noise strength scaler based on the state of the task.

9. The AI method of claim 1, wherein the robust transformation of the input data is performed with multi-stage smoothing including a first smoothing to determine the noise level from random perturbation of the input data on a probabilistic distribution with a fixed variance, and a second smoothing to determine the robust transformation of the input data from random perturbation of the input data on a probabilistic distribution having a varying variance defined by the noise level.

10. The AI method of claim 1, further comprising:
embedding the input data into a continuous space using an encoder, such that one or a combination of the variational neural network and the transformation neural network are applied to the encoding of the input data.

11. The AI method of claim 1, wherein the set of random noises includes a set of Gaussian noise tensors, wherein each of the set of Gaussian noise tensors has a shape of a tensor of floating-point values and includes independent Gaussian samples having a mean of zero and a standard deviation defined by the noise level.

12. The AI method of claim 11, wherein each of the perturbed input samples is formed by adding the tensor of floating-point values to features of the input data.

13. The AI method of claim 1, wherein the transformation neural network is a deep neural network trained with an augmented data with a set of augmentation parameters for one or a combination of automatic speech recognition, language modeling, log data modeling, and variants thereof.

14. The AI method of claim 13, wherein the variational neural network and the transformation neural network accepts the set of augmentation parameters as a conditional information.

15. The AI method of claim 1, wherein each of the set of transformations is a tensor of one or more vectors of logits, the method further comprising:
converting each of the one or more vectors of logits into a probability vector using a tempered softmax operation with a tempering factor to produce a set of probability vectors;
averaging the set of probability vectors in a probability space to produce an average probability vector; and
determining the robust transformation of the input data using the average probability vector.

16. The AI method of claim 15, further comprising:
converting the average probability vector with log-likelihoods to produce the robust transformation of the input data.

17. The AI method of claim 1, wherein each of the set of transformations is a tensor of one or more vectors of logits, the method further comprising:
converting each of the one or more vectors of logits into a hard decision by selecting an index of a largest logit value to produce a set of hard decisions; and
aggregating the set of hard decisions to produce the robust transformation of the input data.

18. The AI method of claim 1, wherein the variational neural network is trained to minimize cross entropy (CE) loss and a Kullback-Leibler (KL) divergence by using a regularized loss function combining the CE loss and the KL divergence.

19. The AI method of claim 1, wherein the variational neural network and the transformation neural network are fine-tuned at a target condition.

20. The AI method of claim 1, wherein the variational neural network and the transformation neural network are trained with adversarial training using adversarially perturbed data according to an adversarial model.

21. The AI method of claim 20, wherein the adversarial training uses at least one of: alternating gradient calculation, explicit gradient calculation, or implicit gradient calculation.

22. A system for robust transformation of input data with a neural network, wherein the system comprises at least one processor and at least one non-transitory memory having computer program code instructions stored thereon that cause the processor to:
process the input data with a variational neural network trained with machine learning to produce statistic parameters including a noise level for the input data;
inject a set of random noises sampled on a probabilistic distribution according to the statistic parameters defined by the variational neural network to produce a set of perturbed input samples;
process each of the set of perturbed input samples with a transformation neural network to produce a set of transformations; and
output a combination of the set of transformations as the robust transformation of the input data.
